(19) United States
(12) Patent Application Publication
(10) Pub. No.: US 2025/0190861 A1
(43) Pub. Date: Jun. 12, 2025

(54) ARTIFICIAL INTELLIGENCE ASSISTANT FOR NETWORK SERVICES AND MANAGEMENT

(71) Applicant: Cisco Technology, Inc., San Jose, CA (US)

(72) Inventors: Pengfei Sun, Reno, NV (US); Qihong Shao, Clyde Hill, WA (US); Elissa E. Murphy, Atherton, CA (US); Barak Turovsky, Los Altos, CA (US)

(21) Appl. No.: 18/821,351

(22) Filed: Aug. 30, 2024

Related U.S. Application Data
(60) Provisional application No. 63/608,579, filed on Dec. 11, 2023.
(60) Provisional application No. 63/607,269, filed on Dec. 7, 2023.

(51) Int. Cl. G06N 20/00

(52) U.S. Cl. CPC G06N 20/00

(57) ABSTRACT

An artificial intelligence assistant analyzes network observations to generate regular expressions using an artificial intelligence model for network automation management pipelines that identify and resolve network issues. A method includes obtaining at least one instruction and information about a plurality of enterprise network assets and configuration of an enterprise network that includes the plurality of enterprise network assets and generating at least one regular expression using an artificial intelligence model based on context description of the at least one instruction and the information about the plurality of enterprise network assets and the configuration of the enterprise network. The method further includes generating at least one solution for configuring at least one network asset of the plurality of enterprise network assets based on the at least one regular expression and providing the at least one solution to cause a configuration change in the at least one network asset.

### CROSS-REFERENCE TO RELATED APPLICATIONS

This application claims the benefit of priority under 35 U.S.C. § 119 (e) to U.S. Provisional Application No. 63/607,269, filed on Dec. 7, 2023, and to U.S. Provisional Application No. 63/608,579, filed on Dec. 11, 2023, which are hereby incorporated by reference in their entireties.

### TECHNICAL FIELD

The present disclosure generally relates to computer networks and systems.

### BACKGROUND

Enterprise networks or network infrastructures include many assets and involve various enterprise service functions for equipment and software. Enterprise networks are often managed by a team of information technology (IT) specialists. This is particularly the case for enterprises that have large networks or systems of numerous instances and types of equipment and software. Enterprise assets may encounter various issues such as defects, obsolescence, configurations, workarounds, etc. Many issues are reported from various vendors and other sources. Addressing issues that may arise in the enterprise network is complicated and involves an understanding of the enterprise network, its assets, and its services. Further, it is increasingly difficult to maintain expanding network inventories, deploy proper updates, configure various devices, and/or install various patches to the network. Typically, network configuration and development rely on specific code snippets that are manually input by the IT specialists or loaded by the IT specialists from a network management system.

### BRIEF DESCRIPTION OF THE DRAWINGS

FIG. 1 is a block diagram of a system that includes a network assistant engine that interacts with an enterprise service cloud portal and network/computing equipment and software residing at various enterprise sites of an enterprise network domain, according to an example embodiment.

FIG. 2 is a diagram illustrating components of the network assistant engine of FIG. 1 that generates a network management pipeline or solutions using a generative artificial intelligence model based on network domain knowledge, according to an example embodiment.

FIG. 3 is a diagram illustrating a generation process in which the network assistant engine of FIG. 1 generates regular expressions to identify a network issue by applying reinforcement learning from edit distance score, according to an example embodiment.

FIGS. 4A and 4B are diagrams, respectively, illustrating an offline pre-training process in which the network assistant engine of FIG. 1 learns existing solutions for various network issues and an online fine-tuning process in which the network assistant engine learns to generate solutions for newly encountered issues, according to an example embodiment.

FIG. 5 is a diagram illustrating an interactive intelligent capital (IC) validation system that evaluates performance of a generated solution, according to an example embodiment.

FIG. 6 is a diagram illustrating an interpretable notes generation process in which the network assistant engine of FIG. 1 generates explanations for solutions and/or code snippets, according to an example embodiment.

FIG. 7 is a diagram illustrating a workflow pipeline including a reactive flow in which the network assistant engine of FIG. 1 is initiated by a user to resolve a network issue and a proactive flow in which the network assistant engine of FIG. 1 proactively detects and resolves the network issue, according to an example embodiment.

FIG. 8 is a diagram illustrating components of the network assistant engine of FIG. 1 that generates code snippets for network troubleshooting, deployment, and configuration, based on regular expression (regex) signatures, according to another example embodiment.

FIG. 9 is a diagram illustrating components of a user intention module of FIG. 8 that generates context descriptions based on user input, according to another example embodiment.

FIG. 10 is a diagram illustrating a proactive feedback loop of FIG. 9 in which the user intention module refines retrieved topics to match user's intent, according to another example embodiment.

FIG. 11 is a diagram illustrating components of an auto regular expression generation (RegexGen) module of FIG. 8 that generates regex embeddings for code snippets generation, according to another example embodiment.

FIG. 12 is a diagram illustrating a code generation process in which the auto RegexGen module of FIG. 8 transforms the regex signatures into embedding space to generate code snippets, according to another example embodiment.

FIG. 13 is a diagram illustrating components of a retrieval augmented generation (RAG) driven knowledge base of FIG. 8, according to another example embodiment.

FIG. 14 is a diagram illustrating the structure of the RAG-driven knowledge base of FIG. 8, according to another example embodiment.

FIG. 15 is a view illustrating a user interface that provides generated code snippets to configure one or more assets of an enterprise network, according to another example embodiment.

FIG. 16 is a flow diagram illustrating a computer-implemented method of providing at least one solution to cause a configuration change in the at least one network asset based on at least one regular expression generated using an artificial intelligence model, according to one or more example embodiments.

FIG. 17 is a hardware block diagram of a computing device that may perform functions associated with any combination of operations in connection with the techniques depicted and described in FIGS. 1-3, 4A, 4B and 5-16, according to various example embodiments.

### DESCRIPTION OF EXAMPLE EMBODIMENTS

### Overview

Briefly, artificial intelligence assistant (network copilot engine) analyzes network observations to generate pattern matching based regular expressions using an artificial intelligence model and use the regular expressions to generate network automation management pipelines that identify and resolve network issues.

In one form, a method includes obtaining at least one instruction and information about a plurality of enterprise network assets and configuration of an enterprise network that includes the plurality of enterprise network assets. The method further includes generating at least one regular expression using an artificial intelligence model based on context description of the at least one instruction and the information about the plurality of enterprise network assets and the configuration of the enterprise network. The method further includes generating at least one solution for configuring at least one network asset of the plurality of enterprise network assets based on the at least one regular expression and providing the at least one solution to cause a configuration change in the at least one network asset.

### Example Embodiments

Multiple network management and troubleshooting automation pipelines are being proposed. Some of these management services focus on utilizing different network tools to build a combined platform to visualize, monitor, and gather data. Moreover, large language models (LLMs) are being explored to build online agents for troubleshooting automation.

The general pipelines for those approaches are categorized into two typical methodologies. First methodology builds a comprehensive interface and platform to automate information gathering and preprocessing, while the information analysis and problem-identification still need human experts. Specifically, network engineers need to develop solutions on top of the preprocessed network inputs. Second methodology builds a variety of specialized wrappers, in which the pretrained LLMs are used as an end-to-end service provider. However, existing solutions might not be accurately interpreted relying on current generative artificial intelligence (AI) approach. Further, general purpose driven LLMs usually provide shallow insights, especially when generating code.

While LLMs may be able to provide solutions in some circumstances, there is significant hallucination in the artificial intelligence (AI) modeling (e.g., GPT4, code llama2). There are many challenges when applying LLMs to network related code generation. For example, network related code snippets require high accuracy. Unlike a dialogue system, a question and answer system, or a general code copilot system, the network code snippets are a series of pre-defined rules for specific devices. Even the mildest hallucinations and re-interpretation in the LLM framework may lead to non-usable configuration settings.

Further, network configuration and deployment require multiple steps of implementation i.e., a chain of tasks or sequential actions. These steps are not necessarily presented in all configurations but may be feature dependent. Moreover, different scenarios may require different code snippets. When applying LLMs to adapt to different application scenarios, it requires users to provide very specific prompts to guide the LLM in selecting corresponding code snippets. Otherwise, the LLM may provide redundant or useless information.

Moreover, feature-driven network device configuration and deployment require very specific requests and definition of the tasks. User inputs, on the other hand, are typically unstructured, which creates ambiguities for the LLMs and make it difficult for the LLMs to retrieve corresponding functionalities and modules from a knowledge base. Additionally, considering the hierarchical structures among multiple network configurations and features, it can be challenging for the LLM to understand user's intention and generate a code snippet or multiple code sessions.

Network automation is a desirable feature for managing enterprise networks and for automatically deploying network devices and configuring enterprise assets. In related art, network automation may be defined within a fixed framework with pre-defined steps that are sequentially implemented one-by-one. For instance, multiple templates may be generated, and the programmed code can implement the deployment following the templates. Further, LLMs may be employed to generate insights to help an IT specialist find network problems and update enterprise network configurations. However, when LLMs are employed, network code generation as well as other solutions is not an option at least due to some of the limitations described above.

The techniques presented herein utilize both knowledge database-based solutions framework and the generative AI based solution framework. For example, the reinforcement learning system may be used which is pretrained offline and fine-tuned online to improve the AI-based assistant engine in providing network related services. The AI-based assistant engine generates various solutions including generating code snippets to resolve network issues and configure one or more enterprise assets.

For network engineers/IT operators, their daily jobs, from initial configuration, root cause analysis to troubleshooting, can be challenging on both time and resources. The exponentially expanding network devices and quick iteration further increase the burden on both device deployment and maintenance. Accordingly, automation pipeline in the network domain would help facilitate network management.

However, several challenges exist with respect to automating network automation pipelines. First, in a typical network troubleshooting workflow, network engineers need to identify the root cause, and narrow down the underlying issues. Automatically pinpointing the key issues directly impacts the efficacy of troubleshooting and solution recommendation. Second, based on the identified issue, a network engineer needs to either search in the existing database and find the most matched solution or proactively debug and validate new solutions step-by-step. Both scenarios need a highly intelligent automation model that is domain-knowledge driven. Specifically, for the new issues, the step-by-step interaction between automation model and validating outcomes would aid the efficacy of the automation pipeline.

Moreover, for network device configuration, multiple step command line interface (CLI) based system setting requires network engineers actively involved with the interface. Automating these interactions directly would involve an automation model that is able to generate high quality code snippet and forward-backward validation. The AI-based assistant engine may generate the automation pipeline in the network management including code snippets with forward-backward validation.

The techniques presented herein provide a network assistant engine to automate management in the network domain. The AI-powered network assistant engine utilizes advanced network domain knowledge and network engineer experts' feedback to develop robust and high-quality problem-solving capability within a pretrained LLM's framework. The generated solutions may involve step by step instructions with corresponding code snippets.

The techniques presented herein automatically parse network observations (such as system logs, configuration session, CLI outputs) to generate pattern matching based regular expressions (regex) and locate existing solutions relying on these generated regex. For example, regex is a hidden information layer that serves as a bridge between diagnosis and solution. Regex may be used in the whole lifecycle of network trouble shooting and resolution generation (at various stages of network automation pipeline such as log analysis (search for and extract specific patterns or error messages from logs, simplifying the identification of network issue root causes), configuration validation (against specific rules or standards, ensuring correctly structured and error-free), parsing command output, etc. As such, the techniques presented herein may generate solutions and interactively improve the solutions based on users' feedback. Furthermore, the network assistant engine may also generate step-by-step code snippet for device deployment and configuration.

The techniques presented herein may use generative capability of LLMs and train LLMs to generate regular expression signatures, which allow the model to overcome the hallucination brought by the LLMs and allow the model to be more adaptive to new cases. Instead of directly generating code snippets, the techniques presented herein generate regular expression signatures using LLM to retrieve raw context descriptions from a knowledge base to generate these code snippets.

The techniques presented herein provide a retrieval-augmented generation (RAG) framework-based domain specific LLM to resolve network issues and automatically deploy updates and network configurations. The techniques presented herein provided an end-to-end RAG database structure with feature embedding, feature plain text, feature regex pattern, and code snippets to allow adaptation to a new case, deployment, and configuration without posterior/continuous fine-tuning.

The techniques presented herein may further provide a proactive user intention module that deploys an LLM and RAG to accurately locate features/issues for different downstream tasks. The techniques presented herein may further provide an LLM-based regex generation module that projects raw context description retrieved from RAG database into hierarchically ordered regex signatures to generate these code snippets. As such, the techniques presented herein provide automated network code generation using generative artificial intelligence model. The code snippets may assist IT specialists with troubleshooting, deployment, and configuration for the network infrastructure. In brief, the techniques presented herein provide a network assistant engine driven by network domain knowledge based multi-task generative LLM model.

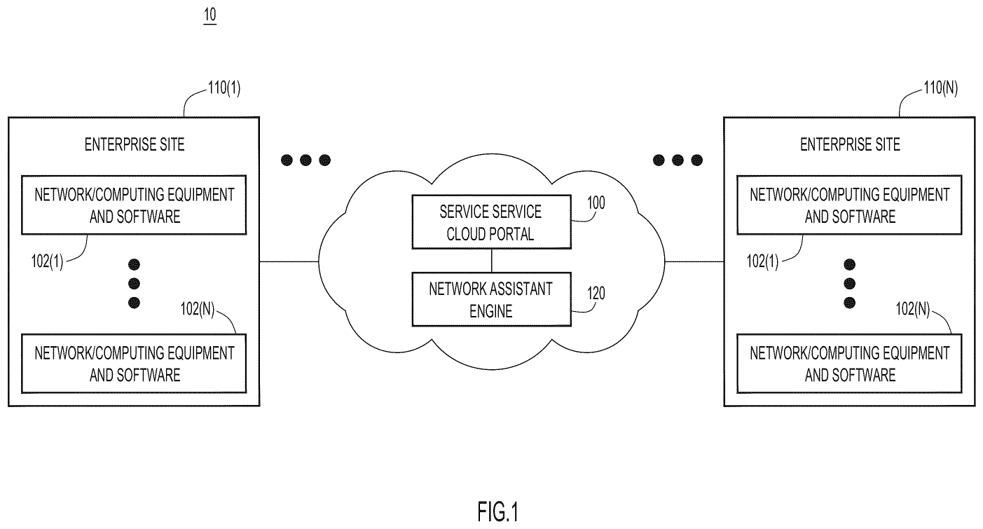

FIG. 1 is a block diagram of a system 10 that includes a network assistant engine 120 that interacts with an enterprise service cloud portal (cloud portal 100) and network/computing equipment and software 102(1)-102(N) residing at various enterprise sites 110(1)-110(N) of an enterprise network, or in a cloud deployment of an enterprise, according to an example embodiment.

The notations 1, 2, 3, . . . n; a, b, c, . . . n; “a-n”, “a-d”, “a-f”, “a-g”, “a-k”, “a-c”, “a-p”, “a-q”, and the like illustrate that the number of elements can vary depending on a particular implementation and is not limited to the number of elements being depicted or described. Moreover, this is only examples of various components, and the number and types of components, functions, etc. may vary based on a particular deployment and use case scenario.

The system 10 is one example of an enterprise network. The system 10 may involve multiple enterprise networks. The network/computing equipment and software 102(1)-102(N) are resources or assets of an enterprise (the terms “assets” and “resources” are used interchangeably herein). The network/computing equipment and software 102(1)-102(N) may include any type of network devices or network nodes such as controllers, access points, gateways, switches, routers, hubs, bridges, gateways, modems, firewalls, intrusion protection devices/software, repeaters, servers, and so on. The network/computing equipment and software 102(1)-102(N) may further include endpoint or user devices such as a personal computer, laptop, tablet, and so on. The network/computing equipment and software 102(1)-102(N) may include virtual nodes such as virtual machines, containers, point of delivery (POD), and software such as system software (operating systems), firmware, security software such as firewalls, and other software products. The network/computing equipment and software 102(1)-102(N) may be in a form of software products that reside in an enterprise network and/or in one or more cloud(s). Associated with the network/computing equipment and software 102(1)-102(N) is configuration data representing various configurations, such as enabled and disabled features. The network/computing equipment and software 102(1)-102(N), located at the enterprise sites 110(1) 110(N), represent information technology (IT) environment of an enterprise.

The enterprise sites 110(1)-110(N) may be physical locations such as one or more data centers, facilities, or buildings located across geographic areas that designated to host the network/computing equipment and software 102(1)-102(N). The enterprise sites 110(1)-110(N) may further include one or more virtual data centers, which are a pool or a collection of cloud-based infrastructure resources specifically designed for enterprise needs, and/or for cloud-based service provider needs. Each enterprise site is a network domain, according to one example embodiment.

The network/computing equipment and software 102(1)-102(N) may send to the cloud portal 100, via telemetry techniques, data about their operational status and configurations so that the cloud portal 100 is continuously updated about the operational status, configurations, software versions, etc. of each instance of the network/computing equipment and software 102(1)-102(N) of an enterprise.

The cloud portal 100 is driven by human and digital intelligence that serves as a one-stop destination for equipment and software of an enterprise to access insights and expertise when needed and specific to a particular stage of an adoption lifecycle. Examples of capabilities include assets and coverage, cases (errors or issues to troubleshoot), automation workbench, insights with respect to various stages of an adoption lifecycle and action plans to progress to the next stage, etc. The cloud portal 100 helps the enterprise network technologies to progress along an adoption lifecycle based on adoption telemetry and enabled through contextual learning, support content, expert resources, and analytics and insights embedded in context of the enterprise's current/future guided adoption tasks.

A network technology is a computing-based service or a solution that solves an enterprise network or a computing problem or addresses a particular enterprise computing need. The network technology may be offered by a service provider to address aspects of information technology (IT). Some non-limiting examples of a network technology include access policies, security and firewall protection services, software image management, endpoint or user device protection, network segmentation and configuration, software defined network (SDN) management, data storage services, data backup services, data restoration services, voice over internet (VOIP) services, managing traffic flows, analytics services, etc. Some network technology solutions apply to virtual technologies or resources provided in a cloud or one or more data centers. The network technology solution implements a particular enterprise outcome and is often deployed on one or more of the network/computing equipment and software 102(1)-102(N).

An adoption of network technology solution refers to enterprise's uptake and utilization of a network technology for achieving a desired outcome. A journey refers to end-to-end activities performed by an enterprise when adopting a network technology including tasks they perform and defined stages to progress. An adoption lifecycle refers to a step-by-step guidance along the adoption journey to accelerate the speed to value of a network technology. The adoption lifecycle may encompass the end-to-end journey stages of: need, evaluate, select, align, purchase, onboard, implement, use, engage, adopt, optimize, recommend, advocate, accelerate, upgrade, renew, etc.

As noted above, various IT specialists (users) interact with the cloud portal 100 to manage network devices and software of the enterprise. There are many factors for a user to consider when building, operating, and maintaining enterprise network(s) and/or data center(s).

For example, an enterprise network may include dispersed and redundant sites such as the enterprise sites 110(1)-110(N) to support highly available services (e.g., network at various geographic locations). These enterprise sites 110(1)-110(N) include network/computing equipment and software 102(1)-102(N), which may be different hardware and software that host network services needed for the enterprise services (e.g., product families, asset groups). Different types of equipment run different features and configurations to enable the enterprise services.

Moreover, each device or group of devices may encounter various issues. In one example embodiment, these issues involve network related problems or potential problems. Network related problems may involve an outage, a latency problem, a connectivity problem, a malfunction of the network device or software thereon, and/or incompatibility or configuration related problems. In one example embodiment, issues may involve defects, obsolescence, configurations, workarounds, network patches, network information, etc. Issues may relate to warranties, licenses, security alerts, or may be informational notices e.g., for a particular configuration or upgrade. To resolve these issues without or with minimal input from an IT specialist, the network assistant engine 120 may be deployed.

The network assistant engine 120 is a multi-task generative model combining the network domain knowledge and reinforced by network expert feedback. The network assistant engine 120 combines the knowledge database pattern query based troubleshooting system with a generative AI based resolution generation approach. The network assistant engine 120 systematically automates the pipeline of root cause analysis, network issue pattern extraction, resolution generation, solution validation within the network troubleshooting framework. The network assistant engine 120 leverages the pretrained large language model as backend to fine-tune a high accurate regex generator in network domain by utilizing comprehensive network knowledge database including troubleshooting and product configuration.

The network assistant engine 120 may employ both Reinforcement Learning from Human Feedback (RLHF) and Reinforcement Learning from Edit Distance Score (RLEDS) framework to enhance the engine's performance. The network assistant engine 120 may involve an interactive validation system employing an unsupervised scoring system for effective reinforcement learning from online human feedback. The network assistant engine 120 may be configured to validate the solution based on whether the network issue was resolved and generate a feedback score for this solution. The feedback score is positive when the solution is validated and is negative when the solution did not resolve the issue. The feedback score is provided to the artificial intelligence model to fine-tune the model.

In one or more example embodiments, the network assistant engine 120 may utilize comprehensive network data to generate code-aid system for product deployment and configuration. The network assistant engine 120 uses generative artificial intelligence model to troubleshoot network issues and to automate network deployment and configuration. Specifically, the network assistant engine 120 employs network domain specific LLM for network issue resolution, network deployment, and configuration automation. An end-to-end RAG database structure includes feature embedding, feature plain text, feature regex pattern, and code snippets to allow adaptation to new cases, deployments, and configuration without posterior/continuous fine-tuning. The network assistant engine 120 may include a proactive user intention module that employs LLM and RAG to determine features/issues for different downstream tasks and an LLM-based regex generation module that projects the raw context description retrieved from RAG database into hierarchically ordered regex signatures.

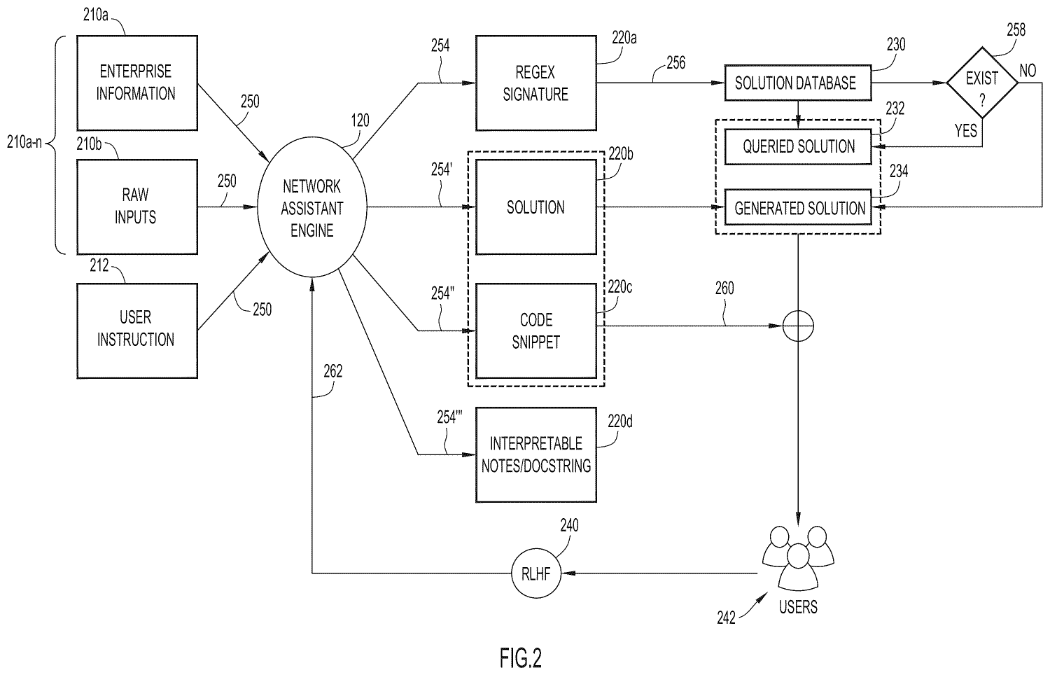

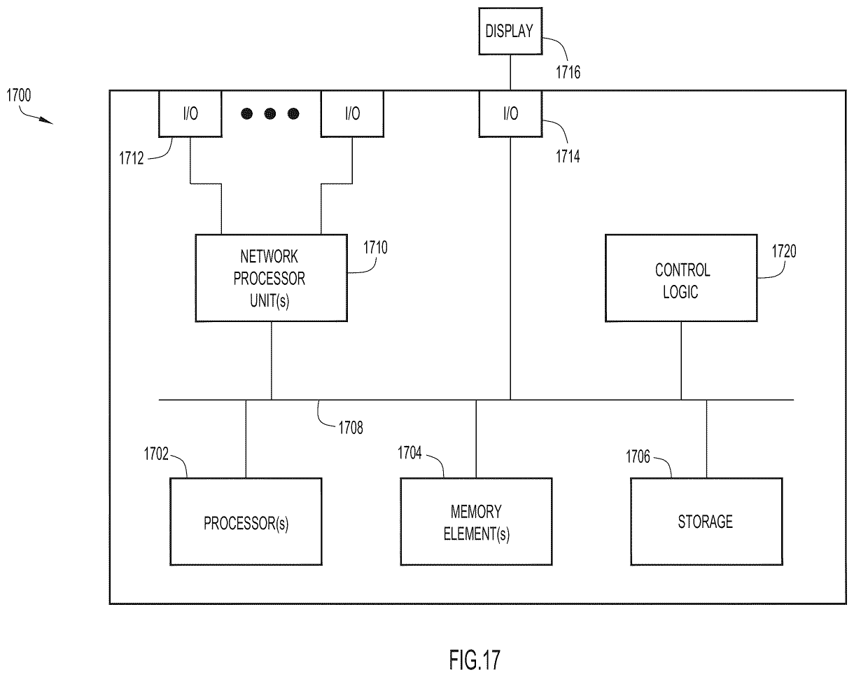

With continued reference to FIG. 1, FIG. 2 is a diagram illustrating components of the network assistant engine 120 of FIG. 1 that generates a network management pipeline or solutions using a generative artificial intelligence model based on network domain knowledge, according to an example embodiment. The network assistant engine 120 may be implemented by one or more computing devices such as the computing device of FIG. 17, by a group of servers, and/or in the cloud. The network assistant engine 120 is a multi-task generative artificial intelligence model that is configured to output regular expressions or regular expression signatures. For example, the network assistant engine 120 may be a large language model (LLM) trained to generate solutions, regular expressions, code snippets, and/or explanations of the foregoing.

Specifically, the network assistant engine 120 obtains input including context information 210a-n and a user instruction 212 to generate a regular expression signature 220a (regex), a solution 220b, a code snippet 220c, and/or natural language documents (interpretable notes/DocString 220d) based on a solution database 230. The network assistant engine 120 is trained and fine-tuned using a reinforcement learning human feedback loop 240 (RLHF loop). The reinforcement learning human feedback loop 240 involves a queried solution 232 or a generated solution 234, the code snippet 220c that is part of the selected solution, and users 242.

The context information 210a-n may include information about a plurality of enterprise network assets i.e., enterprise information 210a and raw inputs 210b. The enterprise information 210a includes data about the network/computing equipment and software 102(1)-102(N) such as type, location, connections, enabled/disabled features, configurations, etc. As an example, the enterprise information 210a includes product information, software version(s), platform information, etc.

The context information 210a-n may further include raw inputs 210b. The raw inputs 210b include data related to configuration and current state of the enterprise network and/or its assets. The raw inputs 210b may include log files, field notices, security advisories, documents, and/or descriptions, bugs, issues, alerts, etc. The raw inputs 210b include configuration of an enterprise network including statuses of the plurality of enterprise network assets.

The user instruction 212 includes an instruction or a request from a user and/or the cloud portal 100. The user instruction 212 may be input in a natural language format and may involve a request to troubleshoot a network issue and/or reconfigure an asset or a group of assets of the enterprise network. For example, the user instruction 212 may be a user request to fix a network issue, which may also request a corresponding code snippet for a configuration action in the set of configuration actions. As another example, the user instruction 212 may be user input to deploy a particular information technology on a set of network assets.

The network assistant engine 120 is a generative multi-task artificial intelligence model e.g., LLMs backed engine that consumes the context information 210a-n. The network assistant engine 120 generates various outputs based on the user instruction 212. The outputs include regular expression signature 220a, the solution 220b, the code snippet 220c, and/or the interpretable notes/DocString 220d. That is, the network assistant engine 120 may generate the regular expression signature 220a with a corresponding solution recommendation (the solution 220b), step-by-step corresponding code snippet (the code snippet 220c) and relevant explanations (interpretable notes/DocString 220d). Specifically, instead of using the network assistant engine 120 to retrieve a solution from the solution database 230, the network assistant engine 120 generates the regular expression signature 220a, which is then fed into the solution database 230 to retrieve a solution e.g., the queried solution 232. As such, the queried solution 232 may be compared with the generated solution 234, thus combining query-based solution fetching with generative AI based solution generation. By obtaining the queried solution 232 and having the network assistant engine 120 generate the solution 220b (the generated solution 234), hallucinations and variations of a generative AI model may be addressed. By employing the regular expression signature 220a as a concise representation (e.g., embeddings in LLM), the system counteracts the artifacts brought by the LLMs since multiple regex patterns may represent the same token sequence.

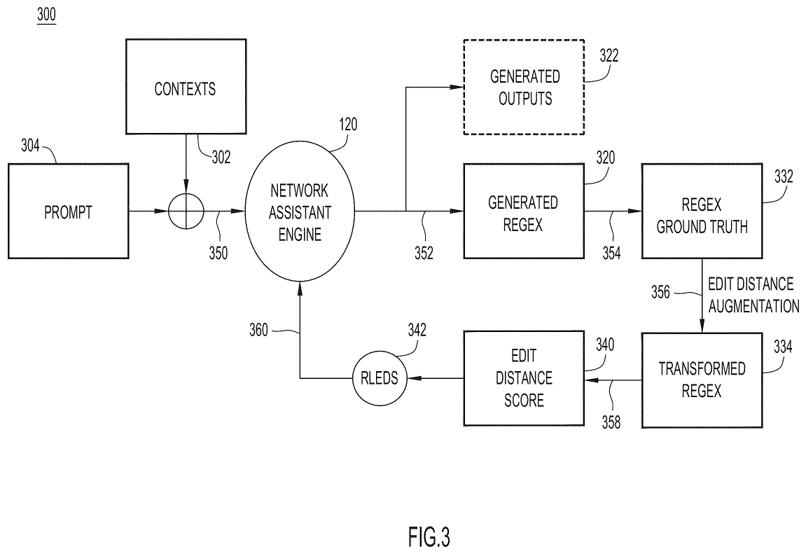

Additionally, the network assistant engine 120 uses reinforcement learning human feedback loop 240 to improve solution generation by the network assistant engine 120, an example of which is described in FIGS. 3, 4A, 4B and 5.

Specifically, at 250, the network assistant engine 120 obtains the user instruction 212 and obtains the context information 210a-n, at 252. At 254, the network assistant engine 120 generates the regular expression signature 220a based on context description of the at least one instruction and the information about the plurality of enterprise network assets and the configuration of the enterprise network. At 254′, the network assistant engine 120 may further generate the solution 220b and at 254″, the network assistant engine 120 may further generate the code snippet 220c and at 254′″, the interpretable notes/DocString 220d.

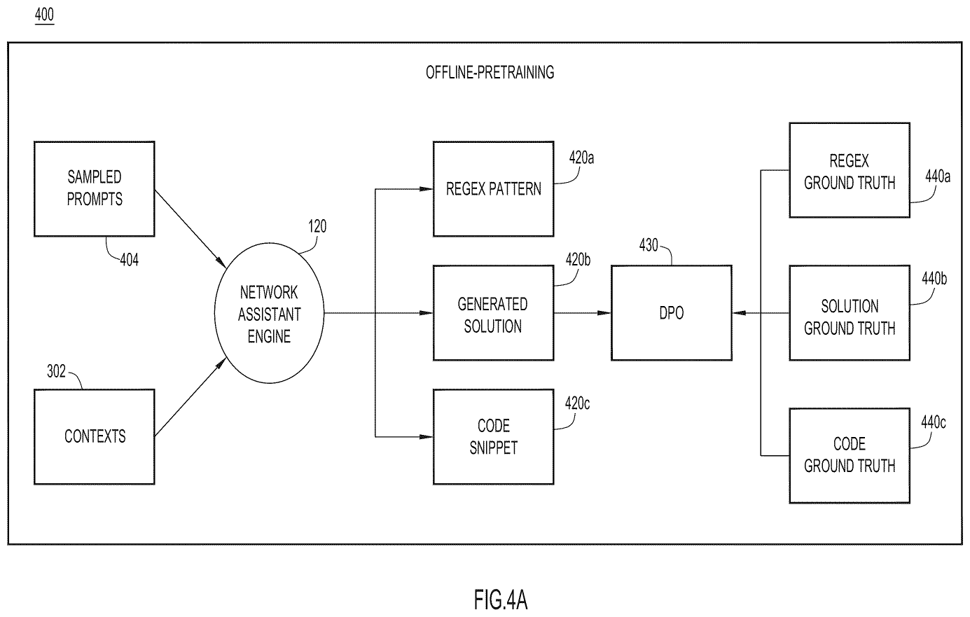

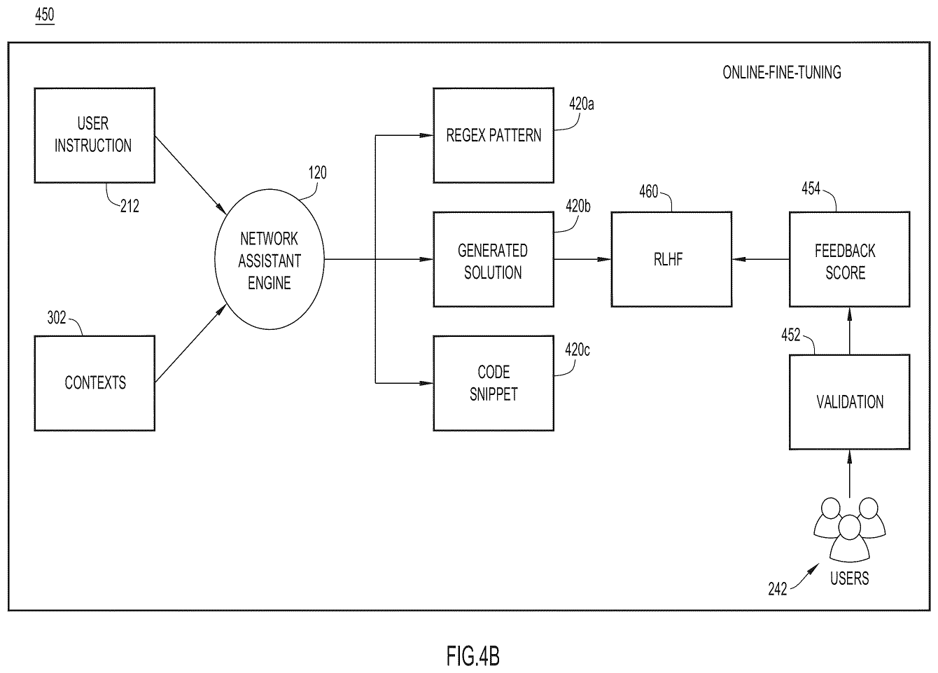

At 256, the regular expression signature 220a is then used to retrieve a solution in the solution database 230. At 258, if the solution exists, the queried solution 232 is provided to the users 242. On the other hand, if the solution could not be found at 258, the generated solution 234 is provided to the users 242. The solution may further include the code snippet 220c, which is also provided to the users 242, at 260. That is, the solution may include a set of configuration actions to perform to fix a network issue and a corresponding code snippet for a configuration action in the set of configuration actions. In one example embodiment, the configuration actions may be performed by the cloud portal 100 with the outcome reported to the users 242. At 262, the outcome of the solution i.e., whether the network issue is resolved, is fed back to the network assistant engine 120 via the reinforcement learning human feedback loop 240, an example of which is described in FIGS. 4A and 4B.

With continued reference to FIGS. 1 and 2, FIG. 3 is a diagram illustrating a generation process 300 in which the network assistant engine 120 of FIGS. 1 and 2 generates regular expressions to identify a network issue by applying reinforcement learning from edit distance score, according to an example embodiment. The generation process 300 involves contexts 302 and a prompt 304, as inputs, to the network assistant engine 120, which then generates regular expressions (generated regex 320) to match other outputs (generated outputs 322). The network assistant engine 120 is trained using regex ground truth 332, which are augmented into transformed regex 334 with an edit distance score 340 being calculated and fed back into the network assistant engine 120 i.e., thus performing reinforcement learning from the edit distance score (RLEDS 342).

In the generation process 300, at 350, the network assistant engine 120 obtains the contexts 302 and the prompt 304 and at 352, creates the generated regex 320. The prompt 304 may include instruction(s) that identify network issues, for example. The contexts 302 may involve raw logs and other documents that explain the solutions to the network issue e.g., field notices, design arounds, etc. The network assistant engine 120 automatically parses the information from network observations i.e., the prompt 304 and the contexts 302 and generates regex signatures (the generated regex 320). The generated regex 320 is used to match the key issues and topics in the contexts 302 (i.e., raw logs and other documents). The automatic regex generation performed by network assistant engine 120 may correspond to a human-based issue identification procedure. The generated regex signatures (the generated regex 320) may be used as keywords to lookup existing solutions (i.e., the generated outputs 322), and thus introduce a mechanism to fully utilize existing factuality of knowledge database. For example, one or more solutions to resolve a network issues are retrieved using the generated regex 320.

In one example embodiment, the generated regex 320 may be considered the regex ground truth 332. That is, high quality human generated regular expressions (the regex ground truth 332) may be applied for training the network assistant engine 120 to accurately generate the regex signatures. In one example embodiment, the generated regex 320 may be considered a regex ground truth 332 and used to train the network assistant engine 120, shown at 354.

Specifically, in the training phase, multiple data augmentation techniques may be applied to train the network assistant engine 120. The data augmentation techniques may involve paraphrasing the contexts 302, raw inputs and/or regular expressions, employing a prompt generator for diversifying prompts, and performing edit-distance based reinforcement learning augmentation on the regex ground truth 332.

For example, at 356, an edit distance augmentation technique is applied to the regex ground truth 332 to generate a transformed regex 334. The transformed regex 334 has a “defect” in which random characters are used to replace original characters in the regex ground truth 332. As such, at 358, the edit distance score 340 is calculated based on the regex ground truth 332 and the transformed regex 334.

At 360, the transformed regex 334 and the edit distance score 340 are input into the network assistant engine 120 i.e., performing reinforcement learning from the edit distance score (the RLEDS 342). That is, for edit-distance score-based reinforcement learning, the network assistant engine 120 relies on generating “defect” regex samples in which random characters are used to replace the original characters in the regex string i.e., the transformed regex 334. The penalty reward is calculated based on the edit distance (the edit distance score 340) between the ground truth (the regex ground truth 332) and the transformed regex 334. In one example embodiment, manually generated rewards may guide the network assistant engine 120 to capture the regex pattern accurately and to learn various “defects”. The training process of the network assistant engine 120 is described in detail in FIGS. 4A and 4B.

With continued reference to FIGS. 1-3, 4A and 4B are diagrams, respectively, illustrating an offline pre-training process 400 in which the network assistant engine 120 learns existing solutions for various network issues and an online fine-tuning process 450 in which the network assistant engine 120 learns to generate solutions for newly encountered issues, according to an example embodiment.

In one example embodiment, the network assistant engine 120 may be a two-layer reinforced solution recommendation system. That is, the network assistant engine 120 not only serves as an end-to-end troubleshooting agent but also provides deployment and configuration aid. Correspondingly, two learning framework embed the capabilities regarding troubleshooting and configuration. In other words, in addition to retrieving existing solutions or generating new solutions, code snippets for performing configuration actions are also generated.

In the offline pre-training process 400 in FIG. 4A, the network assistant engine 120 obtains information about a plurality of enterprise network assets and configuration of an enterprise network that includes the plurality of enterprise network assets, as the contexts 302 of FIG. 3. The network assistant engine 120 further obtains sampled prompts 404, which may be sample instructions that a user may input to troubleshoot an issue or perform a configuration action.

Based on these inputs, the network assistant engine 120 generates a regex pattern 420a, a generated solution 420b, and/or a code snippet 420c, as outputs. The network assistant engine 120 uses a direct preference optimizer framework (DPO 430) to learn existing solution knowledge base including the regex ground truth 440a, the solution ground truth 440b, and the code ground truth 440c. That is, the network assistant engine 120 is trained on the existing solution database, in which ground truth solution as the chosen one, and the generated solution as the rejected options. The DPO 430 allows the network assistant engine 120 to maximally learn existing solution knowledge base.

In the online fine-tuning process 450 of FIG. 4B, the network assistant engine 120 specifically targets new issues or requests, which have never been solved before (i.e., not recorded in solution database). The online fine-tuning process 450 obtains the user instruction 212 of FIG. 2, for example, and contexts 302 of FIGS. 3 and 4A. The user instruction 212 may be a new user query e.g., an instruction to solve a newly discovered network issues that was not previously encountered in an enterprise network. Similar to the offline pre-training process 400, the network assistant engine 120 generates the regex pattern 420a, the generated solution 420b, and/or the code snippet 420c. The code snippet 420c may be a set of configuration actions that fix the newly discovered network issue in an enterprise network.

Since the newly generated outputs do not exist in the solutions knowledge base, these outputs should be validated (validation 452) based on whether the generated solution 420b and/or the code snippet 420c resolve the network issue. For example, the users 242 of FIG. 2 may provided positive or negative feedback for the generated outputs. The feedback may be direct or based on subsequent actions by the users 242 e.g., moved to a different issue or trying a new user instruction for the same issue or variation of the same issue. In a proactive way, the users 242 validate the generated solution 420b (the validation 452) and a feedback score 454 is computed based on the validation 452. The feedback score 454 is used for reinforcement learning in each validation round. By utilizing human feedback as a reward, the RLHF framework 460 uses proximal policy optimization method to gradually tune the network assistant engine 120 to generate reasonable solutions for never-seen-before issues or configuration requests.

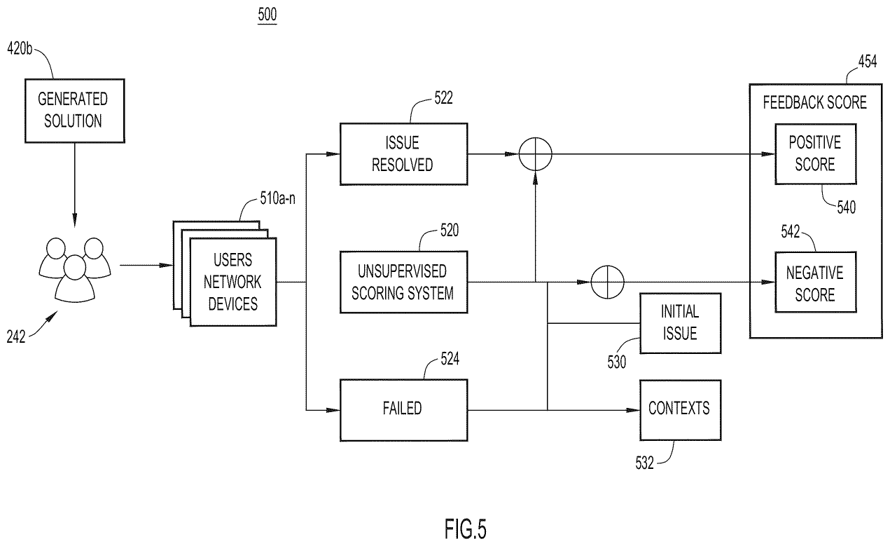

In one example embodiment, the validation 452 may be performed by the cloud portal 100 of FIG. 1. The cloud portal 100 may execute the code snippet 420c and provide feedback based on whether the code snippet 420c resolved the new network issue (partially, completely, only for some of the enterprise assets, etc.). Based on whether the generated solution 420b and/or code snippet 420c are validated, a feedback score 454 is computed. The RLHF framework 460 provides the feedback score 454 to the network assistant engine 120 to fine-tune the network assistant engine 120 for the newly discovered network issues. An example of validating the generated solution 420b is explained in FIG. 5.

With continued reference to FIGS. 1-3, 4A and 4B, FIG. 5 is a diagram illustrating an interactive Intelligent Capital (IC) validation system 500 that evaluates the performance of the generated solution 420b of FIG. 4B, according to an example embodiment. The interactive IC validation system 500 involves the users 242 of FIGS. 2 and 4B, network devices 510a-n, an unsupervised scoring system 520 that generates the feedback score 454 of FIG. 4 based on whether the issue was resolved 522 or the solution failed 524 in which case an initial issue 530 and contexts 532 are also considered for generating the feedback score 454.

The interactive IC validation system 500 as part of reinforced recommendation system evaluates the generated solution 420b. While the interactive IC validation system 500 is described with respect to the generated solution 420b, this is just an example and the disclosure is not limited thereto. The interactive IC validation system 500 may further be configured to validate the code snippet 420c of FIG. 4 in a similar manner and/or other outputs (e.g., notes and documents) generated by the network assistant engine 120 depending on a particular deployment and use case scenario.

The interactive IC validation system 500 deploys the unsupervised scoring system 520 to objectively evaluate the performance of the generated solution 420b. When the generated regex pattern cannot locate an existing solution in a knowledge base, the users 242 may directly apply the generated solution 420b to the network devices 510a-n of an enterprise network. In one example embodiment, the cloud portal 100 may apply the generated solution 420b to a group of target network devices.

The unsupervised scoring system 520 validates whether the initial issue 530 is resolved. That is, the outcome of deploying the generated solution 420b on the network devices 510a-n is provided to the unsupervised scoring system 520 for validation (as positive feedback or negative feedback). If the unsupervised scoring system 520 determines that the issue is resolved 522, the feedback score 454 is computed as a positive score 540. The positive score 540 is provided to the network assistant engine 120 as a reward via the RLHF framework 460 of FIG. 4.

Otherwise, when the solution failed 524 to resolve the initial issue 530, the unsupervised scoring system 520 compares the latest failure report against the initial issue 530, and based on the similarity, the feedback score 454 is computed as a negative score 542. The more similarity the new failure has against the initial issue 530, the less contribution the generated solution 420b is. In one example embodiment, the unsupervised scoring system 520 may further account for the contexts 532. For example, if the generated solution 420b worked for one network device but not another network device, the negative score 542 reflects that the generated solution 420b failed only partially. The negative score 542 is provided to network assistant engine 120 via the RLHF framework 460 to fine-tune solutions being generated for the initial issue 530.

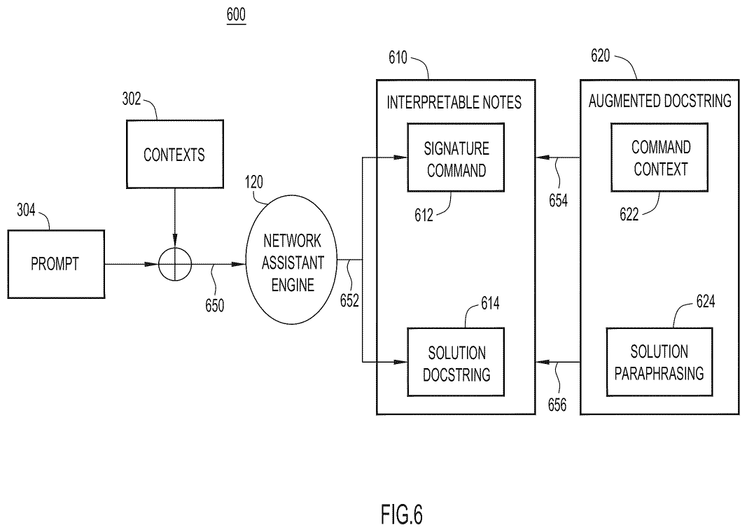

With continued reference to FIGS. 1-3, 4A, 4B and 5, FIG. 6 is a diagram illustrating an interpretable notes generation process 600 in which the network assistant engine 120 of FIG. 1 generates explanations for the solutions and/or code snippets, according to an example embodiment. The interpretable notes generation process 600 involves the network assistant engine 120, which obtains as input the contexts 302 and the prompt 304 to generate the regular expression signature 220a, the solution 220b, and/or the code snippet 220c of FIG. 2 and corresponding explanations (interpretable notes 610) such as the interpretable notes/DocString 220d of FIG. 2.

The interpretable notes generation process 600 involves at 650, the network assistant engine 120 obtaining the contexts 302 and the prompt 304 and generating solutions such as the ones shown in FIG. 2. To explain the solutions being generated, the interpretable notes 610 are also generated by the network assistant engine 120, at 652.

The interpretable notes 610 further include an augmented DocString 620 that includes explanations and instructions for regex signatures, solutions, and/or code snippets. Specifically, the interpretable notes 610 include a signature command 612 that explains the regular expression signature in a natural language. At 654, the signature command 612 is augmented to include command context 622 from the augmented DocString 620. Similarly, at 656, a solution DocString 614 may be augmented with natural language explanation i.e., a solution paraphrasing 624 of the augmented DocString 620.

In one or more example embodiments, to facilitate the adoption of the generated solution and code snippets, the network assistant engine 120 outputs the interpretable notes 610 along with the regex and the generated solution. For example, when the solutions are code snippets, the network assistant engine 120 provides a docstring to help users understand the code's backgrounds, prerequisite, and/or limitations. For regex interpretation, the network assistant engine 120 uses the context summarization to explain the purpose of the regex.

For the solution DocString 614, especially for code snippets, human generation may not necessarily be possible for large scale training dataset. As such, in one example embodiment, a paraphrasing technique is applied on both the context of code and code session itself. For example, another LLM (not shown) is deployed to evaluate the comprehension level of the generated paraphrases. Based on the evaluation outcomes, the techniques select the most understandable paraphrase as the docstring ground truth to scale up the training.

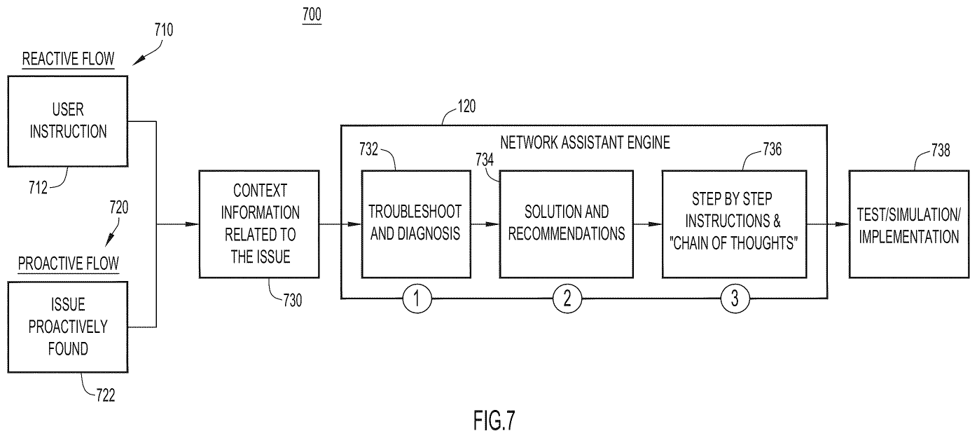

With continued reference to FIGS. 1-3, 4A, 4B, 5 and 6, FIG. 7 is a diagram illustrating a workflow pipeline 700 including a reactive flow 710 in which the network assistant engine 120 is initiated by the user to resolve a network issue and a proactive flow 720 in which the network assistant engine 120 proactively detects and resolves the network issue, according to an example embodiment.

The reactive flow 710 is initiated by one or more users e.g., an IT specialist. For example, at 712, an issue is detected and provided as input to the network assistant engine 120 e.g., in a form of a user instruction or a user prompt, which may be input in a natural language. As an example, the user may input an issue that a security policy A interferes with a relay functionality of devices x, y, and z. As another example, the user may upload one or more documents e.g., a security notice that describes the network issue.

The network assistant engine 120 further obtains, as input, context information about a plurality of enterprise network assets and configuration of an enterprise network that includes the plurality of enterprise network assets. That is, at 730, the network assistant engine 120 obtains context information about the enterprise network associated with the issue. For example, the network assistant engine 120 may obtain configuration information for the devices x, y, and z including enabled and disabled features, type of the devices (e.g., router, switch, etc.) and their role in the enterprise network.

Based on these inputs, the network assistant engine 120 helps with troubleshooting and diagnosis 732, problem solving by generating solution and recommendations 734, and/or configuration actions such as step by step instructions and chain of thoughts 736 e.g., code snippets. For example, the network assistant engine 120 may generate the regular expression signature 220a of FIG. 2 such as:
feature relay protocol x;
interface [virtual local access network], security encryption y, relay address abc;
virtual local access network configuration {xxxxx}, security attach policy.

Based on the regular expression signature 220a, the network assistant engine 120 may locate and retrieve existing solutions from the solution database 230 of FIG. 2. For example, the retrieved solutions may be a first solution instructing to remove the security encryption y from the virtual local access network configuration x in a switch configuration and a second solution instruction to upgrade virtual local access network configuration of the devices x and y to a version 2 or later. Additionally, the network assistant engine 120 may generate code snippets for performing the instructions in the first and second solutions.

At 738, the interactive IC validation system 500 of FIG. 5 may then test, simulate and/or implement the generated solutions and recommendations. For example, the interactive IC validation system 500 may test the first solution and discover that the network issue is resolved for the devices x, y, and z and then test the second solution and discover that the network issue is resolved only for the devices x and y. Based on the foregoing, the interactive IC validation system 500 may recommend the first solution. Along with the first solution, a step by step instructions (code snippets) may be provided. For example, the code snippets may include connection variables in yet another markup language (YAML) such as device type, address, and CLI commands such as connect, address, protocol type, credentials (username, password), enable feature X. As another example, the code snippets may include import required modules and CLI commands with location of these modules. As yet another example, the code snippets may include instruction to load device topology and connect a different port.

In the proactive flow 720, the network assistant engine 120 is deployed to detect one or more network issues, at 722. For example, the network assistant engine 120 may monitor one or more enterprise sites and detect a potentially high risk enterprise site A in which network slowdown and loss of service is detected. That is, the network assistant engine 120 may utilize the regex pattern matching to automatically detect issues and provide “notification prompt” to users informing of the detected issues, and offering one or more solutions generated by the network assistant engine 120 for the troubleshooting and diagnosis 732, for problem solving by generating the solution and recommendations 734, and/or for configuration actions such as the step by step instructions and chain of thoughts 736. As noted above, at 738, the interactive IC validation system 500 may then test the generated solutions. As such, the network assistant engine 120 may provide a summary of the network issue and solutions, affected assets, and other suggestions such as remove security policy X, upgrade relay protocol to version 2 or above, etc.

Users may communicate with the network assistant engine 120 using natural language and obtain, on the fly, detected issues with visual depiction on a network topology map in which the affected assets may be color coded. The users may be provided with one or more solutions, explanations (in a natural language), and/or code snippets for performing the solutions. The users may instruct the network assistant engine 120 to execute the code snippets. The network assistant engine 120 may then communicate with the cloud portal 100 or directly with the affected devices and execute the code snippets and report the results to the user.

The techniques presented herein provide a network assistant engine that supports network management pipelines including collecting detailed information, troubleshooting and diagnosis, instruction-style solution and recommendations, and/or code generation with “Chain of thoughts” (explanations). For example, based on the problem description and the specifications, the network assistant engine generates sequences of relevant regexes, which is then used for configuration issue detection and/or system reconfiguration. Based on the regex signatures, the network assistant engine may locate and retrieve existing solution(s) from internal knowledge database and/or generate new solutions for new network issues, on the fly.

The techniques presented herein may automate management in the network domain. The AI-powered network assistant engine utilizes advanced network domain knowledge and network engineer experts' feedback to develop robust and high-quality problem-solving capability within a pretrained artificial intelligence model (LLMs) framework.

The techniques presented herein may automatically parse network observations (such as system logs, configuration session, command line interface outputs) to generate pattern matching based regular expressions (regex) and locate existing solutions relying on these generated regexes. The regular expressions are a hidden information layer that serves as a bridge between diagnosis and solution. Regular expressions may be used in the whole lifecycle of network troubleshooting and resolution generation (at various stages of the network automation pipeline. For instance, the regular expressions may be used in log analysis i.e., to search for and extract specific patterns or error messages from logs, thus simplifying the identification of network issue root causes. The regular expressions may be used in configuration validation i.e., against specific rules or standards, thus ensuring correctly structured and error-free configurations, parsing command output, etc. The techniques presented herein may also generate solutions and interactively improve the solutions based on users' feedback and various configuration actions. In one or more example embodiments, the network assistant engine is driven by network domain knowledge based multi-task generative LLM model to support various aspects of the network management pipeline.

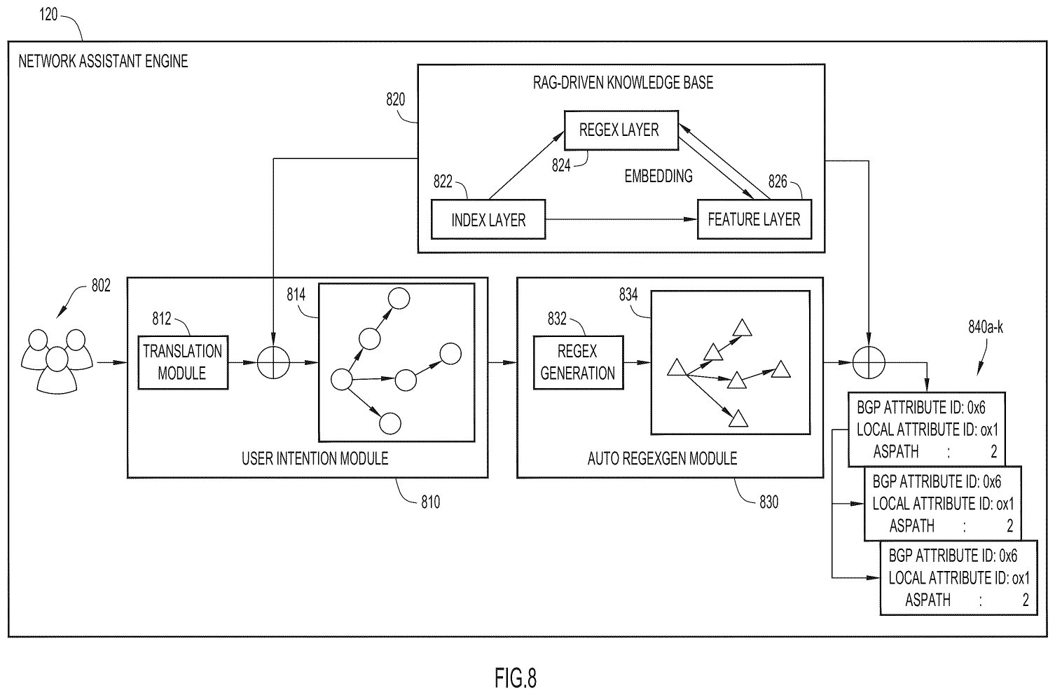

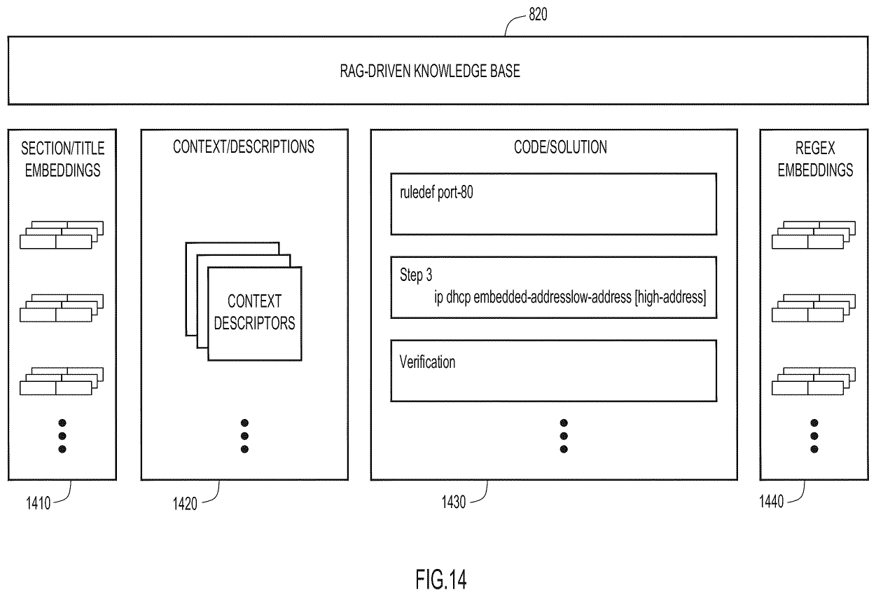

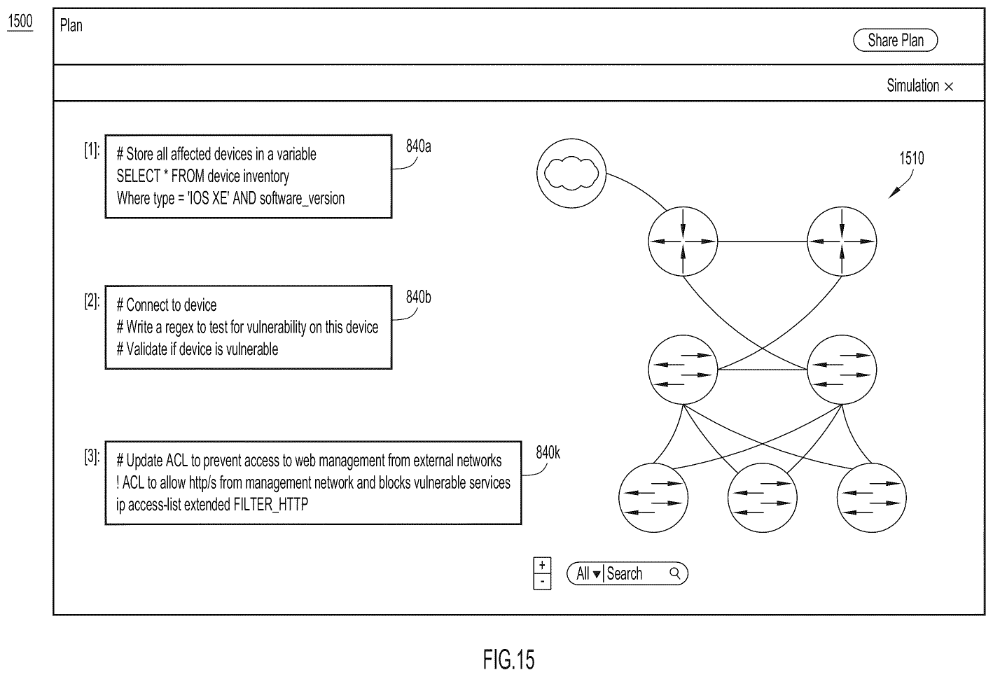

The techniques presented herein may also generate step-by-step code snippets for device deployment and configuration. That is, in one example embodiment, the network assistant engine 120 may be configured to specifically generate code snippets, an example of which is provided in FIGS. 8-15. Just like in one or more example embodiments described in FIGS. 2, 3, 4A, 4B and 5-7, the network assistant engine 120 uses generative capability of artificial intelligence model (LLMs) and train the AI model to generate regular expression (regex) signatures, which may help the AI model to overcome hallucinations and become more adaptive to new cases e.g., newly discovered network issues, new configurations, etc. Instead of directly generating code snippets, the network assistant engine 120 generate regex signatures using the LLM to retrieve raw context descriptions from a knowledge base to generate these code snippets.

In one or more example embodiments described in FIGS. 8-15, the network assistant engine 120 may be a retrieval-augmented generation (RAG) framework-based domain specific LLM that resolves network issues and automatically deploys updates and network configurations.

In this example, the network assistant engine 120 includes an end-to-end RAG database structure with feature embedding, feature plain text, feature regex pattern, and code snippets to allow adaptation to a new case, deployment, and configuration without posterior/continuous fine-tuning. The network assistant engine 120 may further include a proactive user intention module that deploys the LLM and RAG to accurately locate features/issues for different downstream tasks and an LLM-based regex generation module that projects raw context description retrieved from RAG database into hierarchically ordered regex signatures to generate code snippets. As such, the network assistant engine 120 may be tuned or trained to automate network code generation using generative AI. The generated code snippets may assist IT specialists with troubleshooting, deployment, and configuration for the network infrastructure. The tuning of the network assistant engine 120 to generate code snippets may be particularly helpful in assisting IT specialists with mass deployment and configuration updates for large network inventories i.e., large network infrastructure that involve a large set of network devices that may be at various enterprise sites (locations).

With continued reference to FIG. 1, FIG. 8 is a diagram illustrating components of the network assistant engine 120 of FIG. 1 that generates code snippets for network troubleshooting, deployment, and configuration based on regular expression signatures, according to another example embodiment. The network assistant engine 120 includes three stage modules: a user intention module 810 that receives user input 802, a RAG-driven knowledge base 820, and an auto regular expressions generation module (auto RegexGen module 830) that generates code snippets 840a-k.

The user intention module 810 consumes the user input 802. The user input 802 may specify the task at hand e.g., a device configuration task, an upgrade to perform to network devices in an enterprise network with an operating system X, enabling a feature or a service in an enterprise network infrastructure. The user input 802 may be unstructured user inputs e.g., in a natural language format. A translation module 812 translates the user input 802 into feature embeddings. That is, the translation module 812 is configured to understand user's intention of the input in the natural language format. The feature embeddings are combined with information from the RAG-driven knowledge base 820 to select relevant topics i.e., context descriptions 814.

The RAG-driven knowledge base 820 is a hierarchical tree structure that stores existing code snippets as a feature layer 826. For each code snippet, the corresponding context descriptions (index layer 822) are briefed into various regex patterns (regex layer 824). In this way, when trying to retrieve code sessions (e.g., a plurality of related code snippets), through the key regex patterns, the network assistant engine 120 may directly query the regex patterns (the regex layer 824).

The auto RegexGen module 830 consumes the context descriptions 814 that are output by the user intention module 810. The context descriptions 814 are input into a regex generator 832. The regex generator 832 is an artificial intelligence model e.g., an LLM. The regex generator 832 generates regular expression signatures (regex 834), which are then used based on the information in the RAG-driven knowledge base 820 to generate code snippets 840a-k.

With continued reference to FIGS. 1 and 8, FIG. 9 is a diagram illustrating components of the user intention module 810 of FIG. 8 that generates context descriptions based on user input 802, according to another example embodiment. The user intention module 810 includes an LLM 910 and a proactive feedback loop 940. The user intention module 810 uses the RAG-driven knowledge base 820 to generate the context descriptions 814.

The user input 802 may relate to device configuration task, a deployment task, and/or a troubleshooting issue. Since a user may not necessarily be familiar with prompt engineering, the user input 802 may be in an unstructured form e.g., in a natural language format. For example, the user input 802 may be free text, questions, etc. In one example embodiment, the user input 802 may involve attaching a log file, CLI commands, a field notice, a security alert, etc.

The LLM 910 is just one example of an artificial intelligence model that may be deployed in the user intention module 810. The LLM 910 is a generative large language model that is specifically tuned or fine-tuned to map the user input 802 to feature embeddings 920a-h e.g., possible related topics. The feature embeddings 920a-h are regular expression features that may be indicative of the information about relevant enterprise network assets and configurations of the enterprise network.

These feature embeddings 920a-h are then fed into the RAG-driven knowledge base 820 to retrieve relevant topics indicative of the information about relevant enterprise network assets and configurations of the enterprise network i.e., the context descriptions 814. Specifically, the relevant topics may be extracted according to the distance between the generated features (feature embeddings 920a-h) and features in the RAG-driven knowledge base 820. The RAG-driven knowledge base 820 is a hierarchical network knowledge base that includes key features 930 for deployment and configuration. The key features 930 have been tokenized as embeddings, and the key feature embeddings are used as keys. Correspondingly, the detailed context and descriptions within each feature are saved as values. In other words, by searching the top similar embeddings in the RAG-driven knowledge base 820 (i.e., positive matches or close matches based on a similarity search), the related context and background information are extracted as the context descriptions 814. The context descriptions 814 may be hierarchically structured as section topology and/or topics topology. For example, a top context descriptor (e.g., a topic) may be indicative of enabling a feature x and lower level context descriptors may be indicative of information about one set of network apparatuses (e.g., user equipment) and information about another set of network apparatuses (e.g., routers).

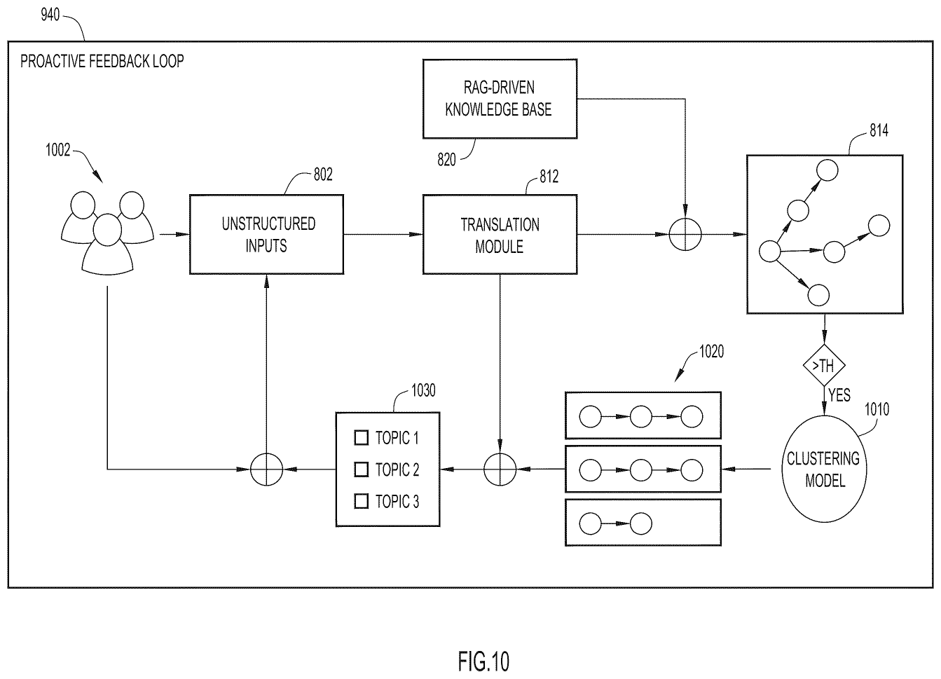

The context descriptions 814 are input into the proactive feedback loop 940 to improve accuracy of user's intent in the user input 802. In one example embodiment, the context descriptions 814 may be provided to a user for selection or clarification of user's intent, an example of which is described in FIG. 10.

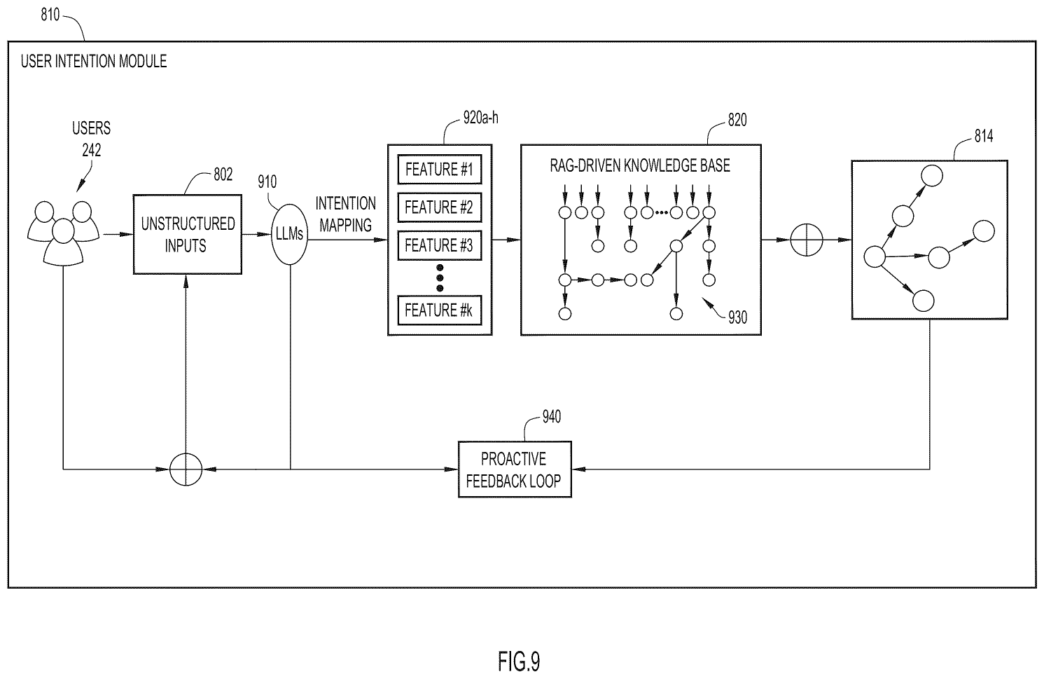

With continued reference to FIGS. 8 and 9, FIG. 10 is a diagram illustrating the proactive feedback loop 940 of FIG. 9 in which the user intention module 810 refines retrieved topics (context descriptions 814 of FIG. 9) to match user's intent, according to another example embodiment. In the proactive feedback loop 940, users 1002 may provide additional feedback by selecting target topics 1030 from topics generated by a clustering model 1010, which include a brief description 1020 indicative of target network issues or configurations associated with a respective topic.

The proactive feedback loop 940 may be employed as a reinforcement learning agent to either learn from users' feedback or assist the users 1002 to confirm their instruction or target network issue. In terms of continuous model training, the proactive feedback loop 940 may retrain the translation module 812 based on a general Reinforcement Learning Human Feedback (RLHF) i.e., positive or negative user feedback.

In one example embodiment, the proactive feedback loop 940 uses the clustering model 1010 for improved accuracy of the translation module 812. That is, if the number of retrieved context descriptions 814 is greater than a predetermined threshold value (e.g., topics topology is large), the clustering model 1010 clusters to retrieved topics into categories or sections and adds a brief description 1020 for each category. These categories are then presented as a list of possible topics to the users 1002. The users 1002 may select the target categories (as target topics 1030) such as a first topic, a second topic, and a third topic. The translation module 812 may then be fine-tuned based on the target topics 1030. That is, the clustering model 1010 is applied to the context descriptions 814 to cluster the topics and the brief description 1020 for each cluster is used as a response to obtain further confirmation to select the target topics 1030.

With continued reference to FIGS. 1 and 8-10, FIG. 11 is a diagram illustrating components of the auto RegexGen module 830 of FIG. 8 that generates regex embeddings for code snippets generation, according to another example embodiment. The auto RegexGen module 830 involves LLMs 1120 that generate the regex 834 based on context descriptions 814 using information in the RAG-driven knowledge base 820.

In the network domain, generating regular expressions may aid in retrieving accurate code snippets or solutions for a network issue. Regular expressions may provide a bridge between troubleshooting and problem resolution. The auto RegexGen module 830 is configured to connect user's intentions with information in the RAG-driven knowledge base 820 to generate target code snippets e.g., code snippets that resolve a network issue that the user is troubleshooting.

The auto RegexGen module 830 obtains as input the context descriptions 814, which are embeddings generated by the user intention module 810. The auto RegexGen module 830 may then retrieve the most correlated topics from the RAG-driven knowledge base 820 by comparing user intention embeddings (the context descriptions 814) against feature embeddings in the RAG-driven knowledge base 820.

Specifically, the auto RegexGen module 830 parses the context descriptions 814 which may include title or section embeddings to generate raw inputs 1110. That is, the auto RegexGen module 830 retrieves context from the context descriptions 814.

For example, each feature/topic related context represents a functionality or a feature module. As an example, the context descriptions 814 may include a switch apparatus series x. The raw inputs 1110 may then include various available connection methods to the switch apparatus series x and a set of instructions to perform (summary steps). The connection methods may be using a console interface for directly connecting troubleshooting apparatus and using a CLI remote access for connecting the troubleshooting apparatus via a telnet access. The raw inputs 1110 may further include managing configuration file for the switch apparatus.

Contexts retrieved from the context descriptions 814 are arranged in a certain order, for instance, step-by-step or multiple session coordination. The underneath logic/reasoning may not be easily revealed considering usually very large context window and hierarchical logic sequences. As such, the context retrieval process reveals these connections or relations in the raw inputs 1110. The raw inputs 1110 are provided to the LLMs 1120. The LLMs 1120 is just one example of an artificial intelligence model and the disclosure is not limited thereto. Other artificial intelligence models are within the scope of this disclosure.

The LLMs 1120 generates regex signatures 1130 based on the raw inputs 1110. For example, the regex signatures 1130 may be “[EXEC], xxx to yyy, [telnet/srouter]”. That is, a regex pattern represents a series of complex matching rules, and a syntax structure organized as a tree structure. Potentially, a chain of thoughts-style prompt engineering either in the LLMs inference phase or fine-tuning stage may better adapt to the multiple-step parsing methodology in regex pattern.

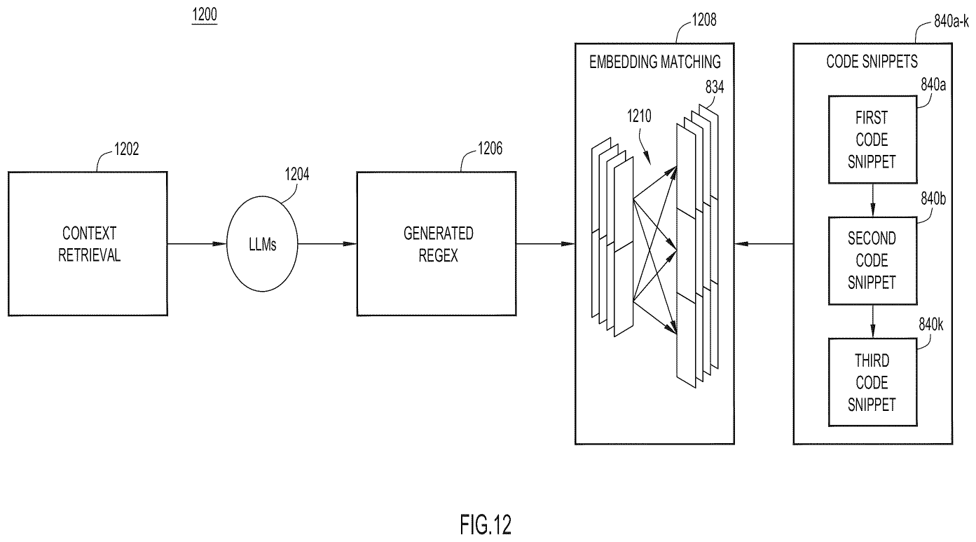

The related art approach that directly inputs the context information into various LLMs and relies on the LLMs to learn the structure of multiple-feature correlations has failed in the network automation task especially when there are multiple code snippet sessions. As such, the auto RegexGen module 830 further refines correlated contexts into a highly representative format, which employ regex (e.g., the regex signatures 1130). By mapping the logically ordered context (raw inputs 1110) into the regex signatures 1130 in the same order, long and dependable context-features may then be transformed into accurate regex sequences or embeddings such as the regex 834, an example of which is shown in FIG. 12.

These regex 834 may then be used to retrieve relevant code snippets or code snippet sessions from the RAG-driven knowledge base 820, shown at 1140. Also, the regex signatures 1130 for new issue may be stored as a new regex embedding in the RAG-driven knowledge base 820.

With continued reference to FIGS. 1 and 8-11, FIG. 12 is a diagram illustrating a code generation process 1200 in which the auto RegexGen module 830 of FIG. 8 transforms regex signatures into an embedding space to generate code snippets 840a-k of FIG. 8, according to another example embodiment.

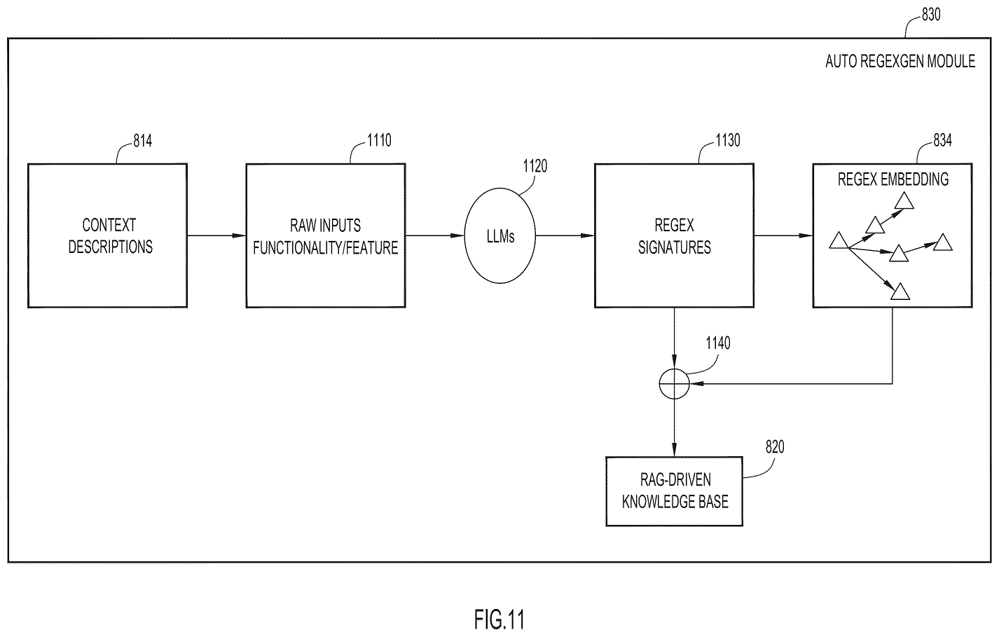

The code generation process 1200 starts with a context retrieval 1202, in which context descriptions are obtained from the user intention module 810 and raw inputs 1110 of FIG. 11 are generated. Next, LLMs 1204 generate regular expression signatures, shown as generated regex 1206.

The code generation process 1200 further involves an embedding matching 1208. That is, the generated regex 1206 are transformed in an embedding space 1210 into regex embeddings (the regex 834). That is, considering inference variation of the LLMs 1204, the regex matching provides a fussy matching approach to pick out or select the most similar regex keys from the RAG-driven knowledge base 820 (not shown). The regex 834 may be efficient to retrieve corresponding code snippets i.e., the code snippets 840a-k. As an example, the code snippets 840a-k may include a first code snippet 840a that may include instructions such as “for an identifier x in a range ( ): extract ( ) and packet.capture( )”, a second code snippet 840b that may include instructions such as “selecting * from xxx”, and a third code snippet 840k that may include instructions such as “deny transmission control protocol (tcp) for any xxx.yyy.zz.0 address”.

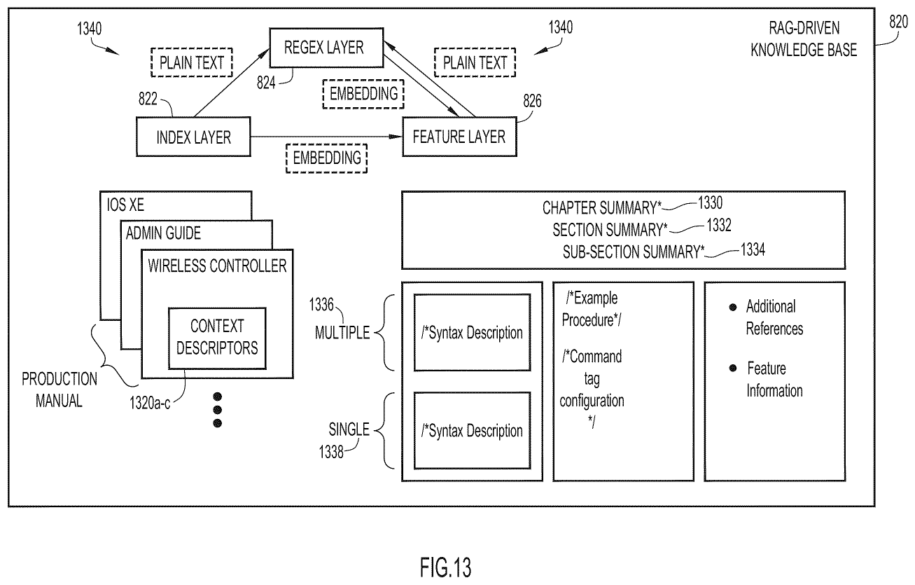

In one example embodiment, when new cases are encountered, there is no need to fine-tune the artificial intelligence model on new patterns/code snippets. Instead, the new case contexts are passed into the network assistant engine 120 and the generated regex embedding (the regex 834) along with the new case's code snippets are saved as key-value pair in the RAG-driven knowledge base 820, an example of which is described in FIG. 13. In this way, the network assistant engine 120 automatically maps description and context to regex embedding for code snippet retrieval, and fine-tuning of the network assistant engine 120 for new cases may be avoided.

With continued reference to FIGS. 1 and 8-12, FIG. 13 is a diagram illustrating components of the RAG-driven knowledge base 820 of FIG. 8, according to another example embodiment. Specifically, the RAG-driven knowledge base 820 includes the index layer 822, the regex layer 824, and the feature layer 826.

In the RAG-driven knowledge base 820, the code snippets are stored in a tree-structured knowledge base. However, for each code snippet, the corresponding contexts and descriptions are briefed into various regex patterns. In this way, when trying to retrieve the code sessions or code snippets, through the key regex patterns, the network assistant engine 120 may directly query the regex patterns. Considering the sequential orders among multiple code snippets, the query regex sequences are in a format that may reflect the latent logic. Additionally, to further avoid various deviations in possible code snippets, a beam search-based method is used by the network assistant engine 120 to find the top candidates. This procedure may be automatically completed by the pre-trained RegexGen LLMs of the network assistant engine 120.

Specifically, the index layer 822, which may be generated by the user intention module 810, includes context descriptors 1320a-c. The context descriptors 1320a-c may include information of a production manual. For example, a first context descriptor may be for a wireless controller and may include mobile access data for directly connecting a troubleshooting apparatus (console), accounting and authorization information such as an accounting identity for telnet access and summary steps, another access and authentication information, etc.; a second context descriptor may be an administrator's guide for a network switch apparatus, and a third context descriptor may be a description of an operating system for a wireless network apparatus. The index layer 822 may capture taxonomy of the network domain (metadata layer).

The feature layer 826 defines internal data schema that may represent a network problem and/or a reconfiguration. It is hierarchically organized for example as a chapter summary 1330, a section summary 1332, and a sub-section summary 1334. It may include a single schema (single 1336) or multiple schemas (multiple 1338). For example, the single 1336 may include (1) syntax description such as command default, command modes, command history, usage guidelines, various examples, and/or related commands, (2) examples with specific procedures, and (3) additional references and/or feature information. The multiple 1338 may also include (1) syntax description such as summary steps, detailed steps, example, troubleshooting tips, and what to do next, (2) command tags and configurations also organized as summary and then detailed steps, and (3) additional references. This is provided by way of an example only.

The index layer 822 with context of the feature layer 826 are both fed into the regex layer 824 in a form of plain text 1340. The regex layer 824 includes regular expression signatures formed based on the plain text 1340. Using regex, relevant code snippets may be retrieved from the RAG-driven knowledge base 820.

With continued reference to FIGS. 1 and 8-13, FIG. 14 is a diagram illustrating a structure of the RAG-driven knowledge base 820 of FIG. 8, according to another example embodiment. The structure of the RAG-driven knowledge base 820 includes section/title embeddings 1410, context descriptions 1420, code/solutions 1430, and regex embeddings 1440.

The title embeddings 1410 correspond to context descriptions 1420. That is, based on title embeddings 1410, corresponding context descriptions 1420 are retrieved. On the other hand, regex embeddings 1440 correspond to the code/solutions 1430 such that using a regex embedding, a corresponding code snippet is retrieved. For example, the code snippet may be:

Ruledef port - 80
Tcp ethernet port = 80
Rule-application routing
Exit
Ruledef news
http uniform resource locator (url) starts with http://news.xxxx
rule-application charging
exit

As such, the network assistant engine 120 may obtain or generate various code snippets, which may be executed for troubleshooting and diagnosis, updates and other configuration actions. As such, the network assistant engine 120 may automatically generate various code snippets that match user's intent.

With continued reference to FIGS. 1 and 8-14, FIG. 15 is a view illustrating a user interface 1500 that provides generated code snippets to configure one or more assets of an enterprise network, according to another example embodiment. The user interface 1500 includes the code snippets 840a-k of FIG. 8 such as a first code snippet 840a, a second code snippet 840b, and a third code snippet 840k and a simulation 1510.

In one example embodiment, the code snippets 840a-k provide step by step instructions to resolve various network issues. For example, the first code snippet 840a may include commands for storing all affected assets in a variable selected * from device inventory with type of operation system and software versions. The second code snippet 840b may include commands to connect to a respective network asset and to write a regex to test for vulnerability on this asset and then validate if the device is vulnerable. The third code snippet 840k may include commands to update an access control list (ACL) to prevent access to web management from external networks including allow http/s from the cloud portal 100 and block vulnerable services, extend internet protocol (IP) access list to filter_http.

Additionally, the simulation 1510 may be depicted with telemetry indicative of applying the code snippets 840a-k on the one or more assets of the enterprise network. The simulation 1510 displays a topology of the enterprise network or portions thereof with assets being reconfigured using the respective code snippet.

In one or more example embodiments of FIGS. 8-15, an LLM-based regex generation module projects raw context description retrieved from RAG database into hierarchically ordered regex signatures. Based on the regex signatures, code snippets are obtained (selected or generated) to resolve network issues, perform reconfiguration, and network updates. The network assistant engine 120 is specifically tuned to understand user's intent based on a natural language input and obtain relevant code snippets using generated regular expression signatures.

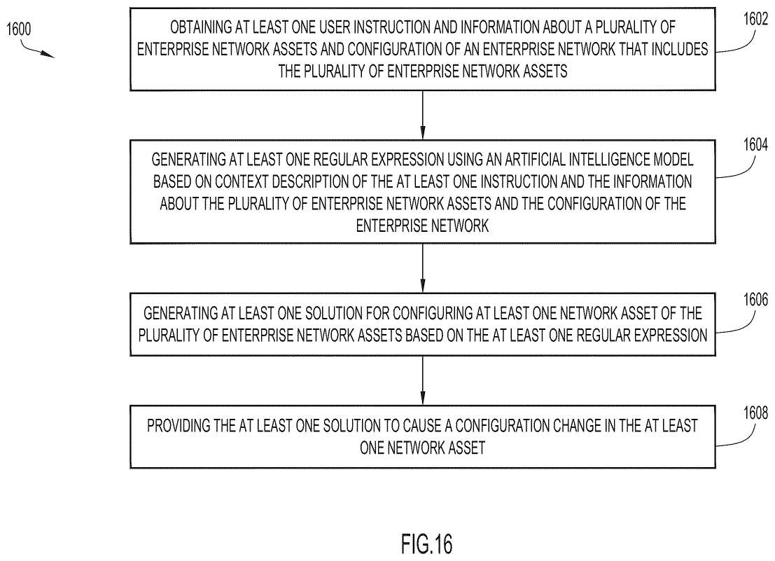

FIG. 16 is a flow diagram illustrating a computer-implemented method 1600 of providing at least one solution to cause a configuration change in the at least one network asset based on at least one regular expression generated using an artificial intelligence model, according to one or more example embodiments.

The computer-implemented method 1600 involves at 1602, obtaining at least one instruction. The operation 1602 further involves obtaining information about a plurality of enterprise network assets and configuration of an enterprise network that includes the plurality of enterprise network assets.

At 1604, the computer-implemented method 1600 involves generating at least one regular expression using an artificial intelligence model based on context description of the at least one instruction and the information about the plurality of enterprise network assets and the configuration of the enterprise network.

At 1606, the computer-implemented method 1600 further involves generating at least one solution for configuring at least one network asset of the plurality of enterprise network assets based on the at least one regular expression and at 1608, the computer-implemented method 1600 further involves providing the at least one solution to cause a configuration change in the at least one network asset.

In one form, the computer-implemented method 1600 may further involve training the artificial intelligence model to generate the at least one regular expression by learning a plurality of regular expressions and corresponding plurality of solutions as ground truths using a reinforcement learning edit distance score feedback loop.

In one instance, the computer-implemented method 1600 may further include configuring the at least one network asset based on the at least one solution. In the computer-implemented method 1600, training the artificial intelligence model may involve tuning the artificial intelligence model using a reinforcement learning feedback loop based on configuring the at least one network asset.

According to one or more example embodiments, tuning the artificial intelligence model may include validating the at least one solution based on whether a network issue is resolved and generating a feedback score for the at least one solution. The feedback score may be positive based on the at least one solution being validated and may be negative based on the at least one solution not being validated. The tuning of the artificial intelligence model may further include providing the feedback score to the artificial intelligence model.

In another form, the artificial intelligence model may be a generative large language model. The operation 1606 of generating the at least one solution may involve generating one or more code snippets by inputting the information and the at least one instruction into the generative large language model and executing the one or more code snippets to configure the at least one network asset.

In one or more example embodiments, the at least one instruction may be a user input in a natural language format. The computer-implemented method 1600 may further involve mapping the user input to a plurality of feature embeddings using the artificial intelligence model and based on a plurality of regular expression features. The plurality of regular expression features may be indicative of the information about the plurality of enterprise network assets and the configuration of the enterprise network.

In one instance, the operation 1604 of generating the at least one regular expression may include generating a sequence of a plurality of regular expression signatures using the artificial intelligence model and based on a mapping of the user input to the plurality of feature embeddings and ordering the plurality of feature embeddings.

In another instance, the operation of generating the one or more code snippets may include obtaining a raw context description for each of the plurality of regular expression signatures in the sequence and generating the one or more code snippets based on the raw context description.

In one or more example embodiments, the artificial intelligence model may be a multi-task generative large language model. The operation 1604 of generating the at least one regular expression may involve generating a plurality of regular expressions based on a network issue using the multi-task generative large language model. The operation 1606 of generating the at least one solution may involve generating a set of configuration actions to perform to fix the network issue and a corresponding code snippet for a configuration action in the set of configuration actions based on the plurality of regular expressions.

FIG. 17 is a hardware block diagram of a computing device 1700 that may perform functions associated with any combination of operations in connection with the techniques depicted in FIGS. 1-3, 4A, 4B and 5-16, according to various example embodiments, including, but not limited to, operations of the cloud portal 100 and/or the network assistant engine 120 of FIGS. 1-3, 4A, 4B and 5-16. It should be appreciated that FIG. 17 provides only an illustration of one embodiment and does not imply any limitations with regard to the environments in which different embodiments may be implemented. Many modifications to the depicted environment may be made.

In at least one embodiment, computing device 1700 may include one or more processor(s) 1702, one or more memory element(s) 1704, storage 1706, a bus 1708, one or more network processor unit(s) 1710 interconnected with one or more network input/output (I/O) interface(s) 1712, one or more I/O interface(s) 1714, and control logic 1720. In various embodiments, instructions associated with logic for computing device 1700 can overlap in any manner and are not limited to the specific allocation of instructions and/or operations described herein.

In at least one embodiment, processor(s) 1702 is/are at least one hardware processor configured to execute various tasks, operations and/or functions for computing device 1700 as described herein according to software and/or instructions configured for computing device 1700. Processor(s) 1702 (e.g., a hardware processor) can execute any type of instructions associated with data to achieve the operations detailed herein. In one example, processor(s) 1702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 1704 and/or storage 1706 is/are configured to store data, information, software, and/or instructions associated with computing device 1700, and/or logic configured for memory element(s) 1704 and/or storage 1706. For example, any logic described herein (e.g., control logic 1720) can, in various embodiments, be stored for computing device 1700 using any combination of memory element(s) 1704 and/or storage 1706. Note that in some embodiments, storage 1706 can be consolidated with one or more memory elements 1704 (or vice versa), or can overlap/exist in any other suitable manner.

In at least one embodiment, bus 1708 can be configured as an interface that enables one or more elements of computing device 1700 to communicate in order to exchange information and/or data. Bus 1708 can be implemented with any architecture designed for passing control, data and/or information between processors, memory elements/storage, peripheral devices, and/or any other hardware and/or software components that may be configured for computing device 1700. In at least one embodiment, bus 1708 may be implemented as a fast kernel-hosted interconnect, potentially using shared memory between processes (e.g., logic), which can enable efficient communication paths between the processes.

In various embodiments, network processor unit(s) 1710 may enable communication between computing device 1700 and other systems, entities, etc., via network I/O interface(s) 1712 to facilitate operations discussed for various embodiments described herein. In various embodiments, network processor unit(s) 1710 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 1700 and other systems, entities, etc. to facilitate operations for various embodiments described herein. In various embodiments, network I/O interface(s) 1712 can be configured as one or more Ethernet port(s), Fibre Channel ports, and/or any other I/O port(s) now known or hereafter developed. Thus, the network processor unit(s) 1710 and/or network I/O interface(s) 1712 may include suitable interfaces for receiving, transmitting, and/or otherwise communicating data and/or information in a network environment.

I/O interface(s) 1714 allow for input and output of data and/or information with other entities that may be connected to computing device 1700. For example, I/O interface(s) 1714 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor 1716, a display screen, or the like.

In various embodiments, control logic 1720 can include instructions that, when executed, cause processor(s) 1702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a memory, a network interface configured to enable network communications and a processor. The processor is configured to perform various operations including obtaining at least one instruction and information about a plurality of enterprise network assets and configuration of an enterprise network that includes the plurality of enterprise network assets. The operations further involve generating at least one regular expression using an artificial intelligence model based on context description of the at least one instruction and the information about the plurality of enterprise network assets and the configuration of the enterprise network. Additionally, the operations may further involve generating at least one solution for configuring at least one network asset of the plurality of enterprise network assets based on the at least one regular expression and providing the at least one solution to cause a configuration change in the at least one network asset.

In yet another example embodiment, one or more non-transitory computer readable storage media encoded with instructions are provided. When the media is executed by a processor, the instructions cause the processor to execute various operations including obtaining at least one instruction and information about a plurality of enterprise network assets and configuration of an enterprise network that includes the plurality of enterprise network assets. The operations may further include generating at least one regular expression using an artificial intelligence model based on context description of the at least one instruction and the information about the plurality of enterprise network assets and the configuration of the enterprise network. Further, the operations may further include generating at least one solution for configuring at least one network asset of the plurality of enterprise network assets based on the at least one regular expression and providing the at least one solution to cause a configuration change in the at least one network asset.

In yet another example embodiment, a system is provided that includes the devices and operations explained above with reference to FIGS. 1-3, 4A, 4B and 5-17.

The programs described herein (e.g., control logic 1720) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 1706 and/or memory elements(s) 1704 can store data, software, code, instructions (e.g., processor instructions), logic, parameters, combinations thereof, and/or the like used for operations described herein. This includes the storage 1706 and/or memory elements(s) 1704 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., TI lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
obtaining at least one instruction and information about a plurality of enterprise network assets and configuration of an enterprise network that includes the plurality of enterprise network assets;
generating at least one regular expression using an artificial intelligence model based on context description of the at least one instruction and the information about the plurality of enterprise network assets and the configuration of the enterprise network;
generating at least one solution for configuring at least one network asset of the plurality of enterprise network assets based on the at least one regular expression; and
providing the at least one solution to cause a configuration change in the at least one network asset.

2. The computer-implemented method of claim 1, further comprising:
training the artificial intelligence model to generate the at least one regular expression by learning a plurality of regular expressions and corresponding plurality of solutions as ground truths using a reinforcement learning edit distance score feedback loop.

3. The computer-implemented method of claim 2, further comprising:
configuring the at least one network asset based on the at least one solution,
wherein training the artificial intelligence model includes:
tuning the artificial intelligence model using a reinforcement learning feedback loop based on configuring the at least one network asset.

4. The computer-implemented method of claim 3, wherein tuning the artificial intelligence model includes:
validating the at least one solution based on whether a network issue is resolved;
generating a feedback score for the at least one solution, wherein the feedback score is positive based on the at least one solution being validated and is negative based on the at least one solution not being validated; and
providing the feedback score to the artificial intelligence model.

5. The computer-implemented method of claim 1, wherein the artificial intelligence model is a generative large language model, and generating the at least one solution includes:
generating one or more code snippets by inputting the information and the at least one instruction into the generative large language model; and
executing the one or more code snippets to configure the at least one network asset.

6. The computer-implemented method of claim 5, wherein the at least one instruction is a user input in a natural language format, and further comprising:
mapping the user input to a plurality of feature embeddings using the artificial intelligence model and based on a plurality of regular expression features, wherein the plurality of regular expression features are indicative of the information about the plurality of enterprise network assets and the configuration of the enterprise network.

7. The computer-implemented method of claim 6, wherein generating the at least one regular expression includes generating a sequence of a plurality of regular expression signatures using the artificial intelligence model and based on a mapping of the user input to the plurality of feature embeddings and ordering the plurality of feature embeddings.

8. The computer-implemented method of claim 7, wherein generating the one or more code snippets includes:
obtaining a raw context description for each of the plurality of regular expression signatures in the sequence; and
generating the one or more code snippets based on the raw context description.

9. The computer-implemented method of claim 1, wherein the artificial intelligence model is a multi-task generative large language model, and generating the at least one regular expression includes:
generating a plurality of regular expressions based on a network issue using the multi-task generative large language model; and
generating the at least one solution including a set of configuration actions to perform to fix the network issue and a corresponding code snippet for a configuration action in the set of configuration actions based on the plurality of regular expressions.

10. An apparatus comprising:
a memory;
a network interface configured to enable network communications; and
a processor, wherein the processor is configured to perform operations comprising:
obtaining at least one instruction and information about a plurality of enterprise network assets and configuration of an enterprise network that includes the plurality of enterprise network assets;
generating at least one regular expression using an artificial intelligence model based on context description of the at least one instruction and the information about the plurality of enterprise network assets and the configuration of the enterprise network;
generating at least one solution for configuring at least one network asset of the plurality of enterprise network assets based on the at least one regular expression; and
providing the at least one solution to cause a configuration change in the at least one network asset.

11. The apparatus of claim 10, wherein the processor is further configured to perform:
training the artificial intelligence model to generate the at least one regular expression by learning a plurality of regular expressions and corresponding plurality of solutions as ground truths using a reinforcement learning edit distance score feedback loop.

12. The apparatus of claim 11, wherein the processor is further configured to perform:
configuring the at least one network asset based on the at least one solution,
wherein the processor is configured to train the artificial intelligence model by:
tuning the artificial intelligence model using a reinforcement learning feedback loop based on configuring the at least one network asset.

13. The apparatus of claim 12, wherein the processor is configured to tune the artificial intelligence model by:
validating the at least one solution based on whether a network issue is resolved;
generating a feedback score for the at least one solution, wherein the feedback score is positive based on the at least one solution being validated and is negative based on the at least one solution not being validated; and
providing the feedback score to the artificial intelligence model.

14. The apparatus of claim 10, wherein the artificial intelligence model is a generative large language model, and the processor is configured to generate the at least one solution by:
generating one or more code snippets by inputting the information and the at least one instruction into the generative large language model; and
executing the one or more code snippets to configure the at least one network asset.

15. The apparatus of claim 14, wherein the at least one instruction is a user input in a natural language format, and the processor is further configured to perform:
mapping the user input to a plurality of feature embeddings using the artificial intelligence model and based on a plurality of regular expression features, wherein the plurality of regular expression features are indicative of the information about the plurality of enterprise network assets and the configuration of the enterprise network.

16. The apparatus of claim 15, wherein the processor is configured to generate the at least one regular expression by generating a sequence of a plurality of regular expression signatures using the artificial intelligence model and based on a mapping of the user input to the plurality of feature embeddings and ordering the plurality of feature embeddings.

17. The apparatus of claim 16, wherein the processor is configured to generate the one or more code snippets by:
obtaining a raw context description for each of the plurality of regular expression signatures in the sequence; and
generating the one or more code snippets based on the raw context description.

18. One or more non-transitory computer readable storage media encoded with software comprising computer executable instructions that, when executed by a processor, cause the processor to perform a method including:
obtaining at least one instruction and information about a plurality of enterprise network assets and configuration of an enterprise network that includes the plurality of enterprise network assets;
generating at least one regular expression using an artificial intelligence model based on context description of the at least one instruction and the information about the plurality of enterprise network assets and the configuration of the enterprise network;
generating at least one solution for configuring at least one network asset of the plurality of enterprise network assets based on the at least one regular expression; and
providing the at least one solution to cause a configuration change in the at least one network asset.

19. The one or more non-transitory computer readable storage media according to claim 18, wherein the computer executable instructions further cause the processor to perform:
training the artificial intelligence model to generate the at least one regular expression by learning a plurality of regular expressions and corresponding plurality of solutions as ground truths using a reinforcement learning edit distance score feedback loop.

20. The one or more non-transitory computer readable storage media according to claim 19, wherein the computer executable instructions further cause the processor to perform:
configuring the at least one network asset based on the at least one solution,
wherein the computer executable instructions cause the processor to train the artificial intelligence model by:
tuning the artificial intelligence model using a reinforcement learning feedback loop based on configuring the at least one network asset.
